(19) United States
(12) Patent Application Publication
(10) Pub. No.: US 2014/0051021 A1
(43) Pub. Date: Feb. 20, 2014

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJI XEROX CO., LTD., Tokyo (JP)

(72) Inventors: Shinya SAKAMOTO, Kanagawa (JP); Shinpei TAKAGI, Kanagawa (JP); Soichiro KITAGAWA, Kanagawa (JP); Tomohiro SHINYA, Kanagawa (JP)

(21) Appl. No.: 13/907,195

(22) Filed: May 31, 2013

(30) Foreign Application Priority Data
Aug. 14, 2012 (JP) 2012-179962

(51) Int. Cl. G03G 9/093; G03G 13/06

(52) U.S. Cl. CPC G03G 9/093; G03G 13/06
USPC 430/109.4; 430/124.1; 399/262; 399/111

(57) ABSTRACT

An electrostatic charge image developing toner includes toner particles that have a core containing polyester, a release agent, and a colorant in which the polyester does not have an ethylenically unsaturated bond, and a shell coating the core and containing a polymer of vinyl monomers, and the toner particles satisfy the following Expression (1): Expression (1): 0.1≦B/(A+B)≦0.7, wherein in Expression (1), A represents a proportion (atom %) of atoms constituting the polyester in the entire atoms, that is obtained by analyzing surfaces of the toner particles by X-ray photoelectron spectroscopy; and B represents a proportion (atom %) of atoms constituting the polymer of vinyl monomers in the entire atoms, that is obtained by analyzing the surfaces of the toner particles by X-ray photoelectron spectroscopy.

### CROSS-REFERENCE TO RELATED APPLICATIONS

This application is based on and claims priority under 35 USC 119 from Japanese Patent Application No. 2012-179962 filed Aug. 14, 2012.

### BACKGROUND

1. Technical Field

The present invention relates to an electrostatic charge image developing toner, an electrostatic charge image developer, a toner cartridge, a process cartridge, an image forming apparatus, and an image forming method.

2. Related Art

Electrophotographic image formation is performed by: charging a surface of a photoreceptor (image holding member); exposing the surface of the photoreceptor in accordance with image information to form an electrostatic charge image; developing the electrostatic charge image with an electrostatic charge image developer including a toner to form a toner image; transferring the toner image onto a surface of a recording medium; and fixing the transferred toner image.

### SUMMARY

According to an aspect of the invention, there is provided an electrostatic charge image developing toner including toner particles that have a core containing polyester, a release agent, and a colorant in which the polyester does not have an ethylenically unsaturated bond, and a shell coating the core and containing a polymer of vinyl monomers, wherein the toner particles satisfy the following Expression (1):

0.1≦B/(A+B)≦0.7 Expression (1):

wherein in Expression (1), A represents a proportion (atom %) of atoms constituting the polyester in the entire atoms, that is obtained by analyzing surfaces of the toner particles by X-ray photoelectron spectroscopy; and B represents a proportion (atom %) of atoms constituting the polymer of vinyl monomers in the entire atoms, that is obtained by analyzing the surfaces of the toner particles by X-ray photoelectron spectroscopy.

### BRIEF DESCRIPTION OF THE DRAWINGS

Exemplary embodiments of the present invention will be described in detail based on the following figures, wherein:

FIG. 1 is a schematic diagram showing the configuration of an example of an image forming apparatus of an exemplary embodiment; and

FIG. 2 is a schematic diagram showing the configuration of an example of a process cartridge of the exemplary embodiment.

### DETAILED DESCRIPTION

Hereinafter, exemplary embodiments of an electrostatic charge image developing toner, an electrostatic charge image developer, a toner cartridge, a process cartridge, an image forming apparatus, and an image forming method of the invention will be described in detail.

Electrostatic Charge Image Developing Toner

An electrostatic charge image developing toner (hereinafter, also referred to as “toner”) of an exemplary embodiment may include toner particles, and may further include an external additive.

The toner particles constituting the toner of this exemplary embodiment have a core and a shell that coats the core. The core contains polyester, a release agent, and a colorant, and the contained entire polyester does not have an ethylenically unsaturated bond. The shell contains a polymer of vinyl monomers (hereinafter, also referred to as “vinyl polymer”).

The toner particles constituting the toner of this exemplary embodiment satisfy the following Expression (1).

0.1≦B/(A+B)≦0.7 Expression (1):

In Expression (1), A represents a proportion (atom %) of atoms constituting the polyester in the entire atoms, that is obtained by analyzing the surfaces of the toner particles by X-ray photoelectron spectroscopy, and B represents a proportion (atom %) of atoms constituting the polymer of vinyl monomers in the entire atoms, that is obtained by analyzing the surfaces of the toner particles by X-ray photoelectron spectroscopy.

A and B in Expression (1) are numerical values that are obtained by analyzing the surfaces of the toner particles by X-ray photoelectron spectroscopy (XPS).

In this exemplary embodiment, the toner particles are analyzed by XPS, and from the measured peak intensities of the elements, a peak component derived from the polyester and a peak component derived from the vinyl polymer are extracted by correction with sensitivity coefficients of the elements with respect to the X-rays to calculate a proportion A (atomic concentration (atom %)) of the atoms constituting the polyester in the entire atoms and a proportion B (atomic concentration (atom %)) of the atoms constituting the vinyl polymer in the entire atoms.

The value of B/(A+B) is thought to reflect a degree of the coating of the core with the shell, and it is thought that the higher the coating degree, the closer to 1 the value of B/(A+B) (it is thought that the lower the coating degree, the closer to 0 the value of B/(A+B)).

In the past, there has been known a toner in which the entire toner particle surface is covered with a vinyl polymer in order to control the surface properties and shape of the toner. However, when a toner image of this toner is fixed, image deletion may occur, and this is more markedly seen, when, as fixing conditions, a fixing temperature is lower and a fixing pressure is lower.

It is thought that the reason for this is that when the entire toner particle surface is covered with the vinyl polymer, the release agent and the resin (for example, polyester) present in the toner particles are difficult to seep into a surface of the toner image, a peeling property between a fixing member in a fixing device and the toner image is reduced, and a part of the toner image is moved to the fixing member, whereby image deletion easily occurs.

The above-described image deletion easily occurs, for example, under the following conditions.

Generally, fixing devices have a tendency that the shorter the time of heating for a recording medium (time during which the fixing member and the recording medium are brought into contact with each other) in the fixing devices, the lower the temperature at the time of fixing. In addition, among electromagnetic induction-type fixing devices, there are devices in which the pressure at the time of fixing is low, as compared with fixing devices (for example, fixing devices provided with a halogen heater as a heater) other than the electromagnetic induction-type fixing devices.

When fixing of a high-density image is continuously performed on a thick sheet of paper (for example, having a basis weight of 256 g/m² or greater) using the above-described device and continuously then fixing of a half-tone image is performed on a thin sheet of paper (for example, having a basis weight of 60 g/m² or less), image deletion particularly easily occur.

When thick sheets of paper are continuously passed, the temperature of the member which is brought into contact with a sheet of paper is easily reduced in the fixing device, and since a half-tone image on the recording medium has a low toner density, a cohesive force between toner particles is week. As a result, it is thought that image deletion is markedly seen under the above-described conditions.

On the other hand, in the case of the toner of this exemplary embodiment, the value of B/(A+B) indicating the surface state of the toner particles is from 0.1 to 0.7, and a shell containing a vinyl polymer partially coats a surface of a core. Therefore, a release agent and polyester contained in the core of the toner particles easily seep into a surface of a toner image, a peeling property between a fixing member in a fixing device and the toner image is favorable, and as a result, it is thought that image deletion is difficult to occur.

In the toner of this exemplary embodiment, the value of B/(A+B) is from 0.1 to 0.7.

When the value of B/(A+B) is greater than 0.7, a degree of the coating of a core with a shell is high, and thus it is thought that the release agent and the polyester contained in the core are difficult to seep into a surface of a toner image. As a result, image deletion may occur.

On the other hand, when the value of B/(A+B) is less than 0.1, the release agent contained in the core excessively seeps into the surface of the toner image and the penetration of the melted toner to a recording medium is inhibited. As a result, image deletion may occur.

In this exemplary embodiment, the value of B/(A+B) is preferably from 0.2 to 0.6, and more preferably from 0.4 to 0.5.

In the toner of this exemplary embodiment, the polyester contained in the core does not have an ethylenically unsaturated bond.

Therefore, for example, when the shell is formed by polymerizing vinyl monomers in a solvent, the polyester of the core and the vinyl polymer of the shell do not form a covalent bond.

When the polyester of the core and the vinyl polymer of the shell are strongly bonded to each other by the covalent bond, the flexibility of a molecular chain deteriorates and the viscosity at the time of melting the resin increases, whereby it is thought that permeation of the release agent is suppressed. However, in the case of toner particles prepared as described above, since it is thought that the vinyl polymer adheres to the surface of the core due to van der Waals force, electrostatic attraction, entanglement between molecules, or the like and forms the shell, it is thought that the above-described problem does not easily occur.

The fact that the polyester contained in the core of the toner particles does not have an ethylenically unsaturated bond may be confirmed by the following method.

A surfactant (for example, Contaminon manufactured by Wako Pure Chemical Industries, Ltd.) is added to ion exchange water, and a toner is added thereto and mixed and dispersed. Ultrasonic waves are applied to the dispersion for from 1 minute to 5 minutes to remove an external additive (for example, silica) from the toner. Thereafter, the dispersion is allowed to pass through filter paper and a residual material on the filter paper is washed with ion exchange water and dried, thereby obtaining toner particles.

Next, from a molded product that is obtained by subjecting the toner particles obtained as described above to compression molding, a slice for scanning transmission x-ray microscope (STXM) observation is prepared. A core of a toner particle in a cross-section of the slice is observed by STXM and the C-K shell NEXAFS spectra of the core of the toner particle is obtained. In addition, a peak area is obtained by subtracting the background with regard to a peak at around 288.7 eV (in the range of from 288 eV to 290 eV) derived from the ethylenically unsaturated bond, and this is set as a C2p peak area of the core of the toner particles. When the C2p peak area of the core of the toner particles is equal to or less than the detection limit, it is judged that the polyester contained in the core of the toner particles does not have an ethylenically unsaturated bond.

Hereinafter, components constituting the toner of this exemplary embodiment will be described.

Binder Resin

In this exemplary embodiment, the core of the toner particles contains, as a binder resin, polyester that does not have an ethylenically unsaturated bond in the molecule.

Examples of the polyester that is a binder resin of the toner particles include amorphous polyester and crystalline polyester.

Hereinafter, the amorphous polyester that does not have an ethylenically unsaturated bond may be referred to as “amorphous saturated polyester”, the crystalline polyester that does not have an ethylenically unsaturated bond may be referred to as “crystalline saturated polyester”, and both may be referred to as “saturated polyester”.

In this exemplary embodiment, the saturated polyester preferably includes polyester prepared using a dicarboxylic acid having an alkyl group with from 8 to 20 carbon atoms (hereinafter, also referred to as “long-chain alkyl group”) as a polyvalent carboxylic acid that is a polymerization component.

The above-described polyester has the long-chain alkyl group derived from the dicarboxylic acid evenly in the molecule, and has appropriate compatibility with a release agent (for example, various waxes). Therefore, it is thought that the polyester and the release agent are dispersed well in the preparation of the toner particles and the release agent is suppressed from being unevenly distributed in the toner particles. As a result, it is thought that the release agent efficiently seeps from the entire toner particle at the time of fixing a toner image, and it is thought that image deletion is more difficult to occur.

The long-chain alkyl group at a side chain of the saturated polyester, derived from the dicarboxylic acid, more preferably has from 8 to 18 carbon atoms from the viewpoint of suppressing the image deletion.

The proportion of the dicarboxylic acid having the long-chain alkyl group in the polyvalent carboxylic acid that is a polymerization component is preferably from 2 mol % to 10 mol %, and more preferably from 4 mol % to 8 mol % from the viewpoint of suppressing the image deletion.

Amorphous Saturated Polyester

The amorphous saturated polyester that is contained in the core of the toner particles is not particularly limited. The amorphous saturated polyester is obtained by, for example, condensation polymerization of polyvalent carboxylic acids and polyols. The amorphous saturated polyester is obtained by using a compound that does not have an ethylenically unsaturated bond as polyvalent carboxylic acids and polyols that are used in the polymerization.

The amorphous saturated polyester is obtained by, for example, performing a condensation reaction of polyvalent carboxylic acids and polyols in the usual manner. The molar ratio (acid/alcohol) in the reaction of polyvalent carboxylic acids and polyols varies with the reaction conditions and the like. Generally, however, the molar ratio is preferably 1/1 to render the molecular weight higher.

Examples of the catalyst for use in the synthesis of the amorphous saturated polyester include esterification catalysts, e.g., organic metals such as dibutyltin dilaurate and dibutyltin oxide and metal alkoxides such as tetrabutyl titanate. The catalyst is used in an amount of from 0.01% by weight to 1.00% by weight with respect to the total amount of the raw materials.

Examples of the polyvalent carboxylic acids for use in the synthesis of the amorphous saturated polyester include dicarboxylic acids, e.g., aromatic carboxylic acids such as terephthalic acid, isophthalic acid, phthalic anhydride, and naphthalene dicarboxylic acid; aliphatic carboxylic acids such as succinic acid and adipic acid; alicyclic carboxylic acids such as cyclohexanedicarboxylic acid; and alkyl group-substituted materials of the carboxylic acids. The polyvalent carboxylic acids may be used singly or in a combination of two or more types. In addition, in order to secure more favorable fixability, tri- or higher-valent carboxylic acids (trimellitic acid, pyromellitic acid, acid anhydrides thereof, and the like) may be used in combination with the dicarboxylic acids to employ a cross-linked structure or a branched structure.

Examples of the polyols for use in the synthesis of the amorphous saturated polyester include aliphatic diols such as ethylene glycol, diethylene glycol, triethylene glycol, propylene glycol, butanediol, hexanediol, and neopentyl glycol; alicyclic diols such as cyclohexanediol, cyclohexanedimethanol, and hydrogenerated bisphenol-A; and aromatic diols such as an ethylene oxide adduct of bisphenol-A and a propylene oxide adduct of bisphenol-A. The polyols may be used singly or in a combination of two or more types.

Among the polyols, aromatic diols and alicyclic diols are preferable, and aromatic diols are more preferable. In addition, in order to secure more favorable fixability, tri- or higher-valent alcohols (for example, glycerin, trimethylolpropane, and pentaerythritol) may be used in combination with the diols to employ a cross-linked structure or a branched structure.

A monocarboxylic acid or a monoalcohol may be further added to the amorphous saturated polyester obtained by polycondensation of polyvalent carboxylic acids and polyols to esterify the hydroxyl group or the carboxyl group at the polymerization terminal to thereby adjust the acid value of the polyester resin. Examples of the monocarboxylic acid include acetic acid, acetic anhydride, benzoic acid, and propionic anhydride. Examples of the monoalcohol include methanol, ethanol, propanol, octanol, 2-ethylhexanol, and phenol.

The glass transition temperature (Tg) of the amorphous saturated polyester is preferably from 45° C. to 80° C., and more preferably from 50° C. to 65° C. from the viewpoints of storage stability and low-temperature fixability of the toner.

The glass transition temperature of the amorphous saturated polyester is obtained as a peak temperature of an endothermic peak obtained by differential scanning calorimetry (DSC).

The acid value of the amorphous saturated polyester is preferably from 5 mg KOH/g to 25 mg KOH/g, and more preferably from 6 mg KOH/g to 23 mg KOH/g from the viewpoints of a charging property of the toner and compatibility with paper. The acid value of the amorphous saturated polyester is measured based on JIS K-0070-1992.

The weight average molecular weight (Mw) of the amorphous saturated polyester is preferably from 10,000 to 1,000,000, more preferably from 50,000 to 500,000, and even more preferably from 50,000 to 100,000 in the molecular weight measurement of tetrahydrofuran (THF) solubles by gel permeation chromatography (GPC).

The proportion of the amorphous saturated polyester in the entire toner particle is preferably from 40% by weight to 95% by weight, more preferably from 50% by weight to 90% by weight, and even more preferably from 60% by weight to 85% by weight.

Crystalline Saturated Polyester

In this exemplary embodiment, the toner particles preferably contain crystalline polyester in the core. The viscosity of the crystalline polyester at the time of melting is lower than that of the amorphous polyester. Accordingly, the release agent and the polyester easily seep at the time of fixing a toner image and image deletion is more suppressed.

In this exemplary embodiment, the crystalline polyester that is contained in the core of the toner particles does not have an ethylenically unsaturated bond in the molecule.

The “crystalline” in the crystalline polyester means that the polyester has a clear endothermic peak without a stepwise change in the heat absorption amount in the differential scanning calorimetry (DSC). Specifically, it means that a half-value width of the endothermic peak in the measurement at a rate of temperature increase of 10° C./min is 10° C. or less.

On the other hand, a resin of which a half-value width of the endothermic peak is greater than 10° C., or a resin of which a clear endothermic peak is not observed means amorphous polyester (amorphous polymer).

In this exemplary embodiment, the “crystalline polyester” also means, in addition to a polymer of which the constituent components constitute a 100%-polyester structure, a polymer (copolymer) in which a component constituting polyester and other components are polymerized together. However, in the latter case, other constituent components other than the polyester constituting the polymer (copolymer) are 50% by weight or less.

The crystalline saturated polyester is synthesized from, for example, polyvalent carboxylic acids and polyols. The crystalline saturated polyester is obtained by using a compound that does not have an ethylenically unsaturated bond as the polyvalent carboxylic acids and the polyols that are used in the synthesis.

Examples of the polyvalent carboxylic acids for use in the synthesis of the crystalline saturated polyester include aliphatic dicarboxylic acids such as oxalic acid, succinic acid, glutaric acid, adipic acid, suberic acid, azelaic acid, sebacic acid, 1,9-nonane dicarboxylic acid, 1,10-decane dicarboxylic acid, 1,12-dodecanedicarboxylic acid, 1,14-tetradecanedicarboxylic acid, and 1,18-octadecanedicarboxylic acid; aromatic dicarboxylic acids such as dibasic acids, e.g., phthalic acid, isophthalic acid, terephthalic acid, naphthalene-2,6-dicarboxylic acid, malonic acid, and mesaconic acid; and anhydrides and lower alkyl esters thereof. These may be used singly or in a combination of two or more types.

Examples of the tri- or higher-valent carboxylic acids include aromatic carboxylic acids such as 1,2,3-benzene tricarboxylic acid, 1,2,4-benzene tricarboxylic acid, and 1,2,4-naphthalene tricarboxylic acid, and anhydrides and lower alkyl esters thereof.

In addition, dicarboxylic acids having a sulfonic acid group may be used in addition to the aliphatic dicarboxylic acids and the aromatic dicarboxylic acids.

The polyols for use in the synthesis of the crystalline saturated polyester are preferably aliphatic diols, more preferably straight chain aliphatic diols with from 7 to 20 carbon atoms in a main chain part, and even more preferably straight chain aliphatic diols with from 7 to 14 carbon atoms in a main chain part from the viewpoints of crystallinity of the polyester resin and low-temperature fixability of the toner.

Specific examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among them, 1,8-octanediol, 1,9-nonanediol, and 1,10-decanediol are preferable in consideration of availability.

Examples of the tri- or higher-valent alcohols for use in the synthesis of the crystalline saturated polyester include glycerin, trimethylolethane, trimethylolpropane, and pentaerythritol. These may be used singly or in a combination of two or more types.

The content of the aliphatic diol in the polyols constituting the crystalline saturated polyester is preferably 80 mol % or greater, and more preferably 90 mol % or greater from the viewpoints of crystallinity of the polyester resin and low-temperature fixability of the toner.

As a polymerizable monomer constituting the crystalline saturated polyester, a polymerizable monomer having a straight chain aliphatic component is more preferable than a polymerizable monomer having an aromatic component, in order to easily form a crystal structure. Furthermore, a constitution ratio of each polymerizable monomer type is preferably 30 mol % or greater in order not to impair the crystallinity.

The crystalline saturated polyester may be synthesized in the usual manner, and the synthesis may be performed at a polymerization temperature of from 180° C. to 230° C. For example, the reaction is carried out while reducing the pressure in the reaction system and removing water or alcohol generated in the condensation.

Examples of the catalyst that is used in the preparation of the crystalline saturated polyester include alkali metal compounds such as sodium and lithium; alkaline-earth metal compounds such as magnesium and calcium; metal compounds such as zinc, manganese, antimony, titanium, tin, zirconium, and germanium; phosphorous compounds; phosphate compounds; and amine compounds.

The melting temperature Tc (° C.) of the crystalline saturated polyester is preferably from 50° C. to 100° C., more preferably from 55° C. to 90° C., and even more preferably from 60° C. to 85° C. in consideration of a storage property and low-temperature fixability of the toner.

The melting temperature Tc (° C.) of the crystalline saturated polyester is obtained as a peak temperature of an endothermic peak obtained by differential scanning calorimetry (DSC).

The acid value of the crystalline saturated polyester is preferably from 3.0 mg KOH/g to 30.0 mg KOH/g, more preferably from 6.0 mg KOH/g to 25.0 mg KOH/g, and even more preferably from 8.0 mg KOH/g to 20.0 mg KOH/g. The acid value of the crystalline saturated polyester is measured based on JIS K-0070-1992.

The weight average molecular weight (Mw) of the crystalline saturated polyester is preferably from 6,000 to 35,000, and more preferably from 10,000 to 30,000 from the viewpoints of fixing unevenness and strength of the image and low-temperature fixability of the toner.

The weight average molecular weight of the crystalline saturated polyester is measured by gel permeation chromatography (GPC).

The proportion of the crystalline saturated polyester in the entire toner particles is preferably from 3% by weight to 40% by weight, more preferably from 4% by weight to 35% by weight, and even more preferably from 5% by weight to 30% by weight.

Other Resins

In this exemplary embodiment, it is preferable that the toner particles do not contain a vinyl polymer in the core. The core may contain a nonvinyl condensation resin (for example, epoxy resins, polyurethane resins, polyamide resins, cellulose resins, and polyether resins).

In this exemplary embodiment, the resin contained in the core is preferably only saturated polyester.

Release Agent

In this exemplary embodiment, the toner particles contain a release agent in the core.

Examples of the release agent include paraffin wax such as low-molecular-weight polypropylene and low-molecular-weight polyethylene; a silicone resin; rosins; rice wax; carnauba wax; Fischer-Tropsch wax; and fatty acid ester.

The melting temperature Tw (° C.) of the release agent is preferably from 50° C. to 100° C., and more preferably from 60° C. to 95° C.

The melting temperature Tc (° C.) of the crystalline polyester and the melting temperature Tw (° C.) of the release agent, that are contained in the core of the toner particles, preferably satisfy the expression |Tc−Tw|≦30. That is, a difference between the melting temperatures of the crystalline polyester and the release agent is preferably 30° C. or less.

When the crystalline polyester and the release agent that are contained in the core of the toner particles have a relationship expressed by the above-described expression, it is thought that a difference between a time at which the crystalline polyester starts to melt and a time at which the release agent starts to melt when passing through the fixing device is small, and it is thought that permeation of the crystalline polyester and the release agent is promoted and image deletion is more difficult to occur.

The proportion of the release agent in the total amount of the toner particles is preferably from 0.5% by weight to 15% by weight, and more preferably from 1.0% by weight to 12% by weight in consideration of peelability and fluidity of the toner.

Colorant

In this exemplary embodiment, the toner particles contain a colorant in the core.

The colorant may be a dye or a pigment. However, the colorant is preferably a pigment from the viewpoints of light resistance and water resistance. In addition, a surface-treated colorant or a pigment dispersant may be used.

As the colorant, a material that has been known in the past may be used with no particular limitation. Preferable examples of the colorant include carbon black, aniline black, aniline blue, Calcoil Blue, Chrome Yellow, Ultramarine Blue, DuPont Oil Red, Quinoline Yellow, Methylene Blue Chloride, Phthalocyanine Blue, Malachite Green Oxalate, Lamp Black, Rose Bengal, quinacridone, Benzidine Yellow, C.I. Pigment Red 48:1, C.I. Pigment Red 57:1, C.I. Pigment Red 122, C.I. Pigment Red 185, C.I. Pigment Red 238, C.I. Pigment Yellow 12, C.I. Pigment Yellow 17, C.I. Pigment Yellow 180, C.I. Pigment Yellow 97, C.I. Pigment Yellow 74, C.I. Pigment Blue 15:1, and C.I. Pigment Blue 15:3.

A yellow toner, a magenta toner, a cyan toner, a black toner, and the like are obtained by selecting the type of the colorant.

The content of the colorant in the toner of this exemplary embodiment is preferably from 1 part by weight to 30 parts by weight with respect to 100 parts by weight of the entire resin contained in the toner particles.

Vinyl Polymer

In this exemplary embodiment, in the toner particles, the core containing the polyester, the release agent, and the colorant is coated with the shell containing the polymer of vinyl monomers (vinyl polymer). Here, the coating means that the shell coats at least a part of the surface of the core.

In this exemplary embodiment, the shell may contain a component other than the vinyl polymer, such as a urethane polymer or an acryl polymer. In this exemplary embodiment, it is preferable that the shell does not contain polyester, and it is preferable that only the vinyl polymer is contained as the resin.

In this exemplary embodiment, the vinyl monomer is a monomer that may be vinyl-polymerized and in which one molecule has at least one vinyl group.

Examples of the polymer of vinyl monomers include homopolymers or copolymers (styrene resins) of styrene monomers such as styrene, parachlorostyrene, α-methylstyrene; homopolymers or copolymers of acrylic acid esters having a vinyl group and methacrylic acid esters having a vinyl group such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; homopolymers or copolymers of vinyl nitriles such as acrylonitrile and methacrylonitrile; homopolymers or copolymers of vinyl ethers such as vinyl methyl ether and vinyl isobutyl ether; and homopolymers or copolymers of vinyl ketones such as vinyl methyl ketone, vinyl ethyl ketone, and vinyl isopropenyl ketone.

Among them, homopolymers or copolymers (styrene resins) of styrene monomers are preferable, and homopolymers of styrene are more preferable from the viewpoint of environmental stability of the charge amount of the toner particles.

In this exemplary embodiment, the weight average molecular weight of the vinyl polymer is preferably from 40,000 to 70,000, and more preferably from 50,000 to 60,000 from the viewpoint of low-temperature fixability.

In this exemplary embodiment, the proportion of the vinyl polymer in the total amount of the toner particles is preferably from 3% by weight to 15% by weight, and more preferably from 6% by weight to 10% by weight from the viewpoint of low-temperature fixability.

Other Additives

In this exemplary embodiment, the toner particles may contain an internal additive or a charge control agent other than the above-described components.

Examples of the internal additive include metals such as ferrite, magnetite, reduced iron, cobalt, nickel, and manganese, alloys thereof, or magnetic materials such as compounds containing the metals.

Examples of the charge control agent include, as negative charge control agent, trimethylethane dyes, metal complex salts of salicylic acid, metal complex salts of benzilic acid, copper phthalocyanine, perylene, quinacridone, azo pigments, metal complex salt azo dyes, heavy-metal containing acidic dyes such as an azochrome complex, calixarene-type phenol condensate, and cyclic polysaccharide.

External Additive

The toner of this exemplary embodiment may contain various components such as inorganic particles (inorganic powders) and organic particles as external additives.

The inorganic particles are added for various purposes, but may be added to adjust the viscoelasticity of the toner. The image gloss and the penetration to paper are controlled by adjusting the viscoelasticity. Examples of the inorganic particles include silica particles, titanium oxide particles, alumina particles, cerium oxide particles, and particles obtained by hydrophobizing the surfaces of the above particles. Silica particles having a lower refractive index than the binder resin are preferably used from the viewpoint that a color restoring property or transparency such as OHP permeability is not deteriorated. Silica particles may be subjected to various surface treatments. For example, silica particles surface-treated with a silane coupling agent, a titanium coupling agent, silicone oil, or the like are preferably used.

The proportion of the inorganic particles mixed in the toner is generally from 0.01 part by weight to 5 parts by weight, and preferably from 0.01 part by weight to 2.0 parts by weight with respect to 100 parts by weight of the toner.

Together with the inorganic particles, resin particles (resin particles of polystyrene, a polymethylmethacrylate resin, a melamine resin, and the like), metal salts of higher fatty acids represented by zinc stearate, and fluorine polymer powder particles may be used.

Characteristics of Toner

The volume average particle size of the toner of this exemplary embodiment is preferably from 4 μm to 9 μm, more preferably from 4.5 μm to 8.5 μm, and even more preferably from 5 μm to 8 μm. When the volume average particle size is 4 μm or greater, the toner fluidity is improved and the charging property of the respective particles is easily improved. In addition, since the charging distribution is not expanded, background fogging, toner spilling from a developing machine, and the like are difficult to occur. When the volume average particle size is 4 μm or greater, cleanability does not deteriorate. When the volume average particle size is 9 μm or less, the resolution is improved, and thus sufficient image quality is obtained and a demand for high image quality in recent years is satisfied.

The volume average particle size is measured using a Coulter Multisizer (manufactured by Beckman Coulter, Inc.) with an aperture diameter of 50 μm. In this case, the measurement is performed after the toner is dispersed in an electrolyte aqueous solution (ISOTON aqueous solution) and dispersed with ultrasonic waves for 30 seconds or longer.

The toner of this exemplary embodiment preferably has a spherical shape having a shape factor SF1 of from 110 to 140. When the shape is spherical in this range, favorable transfer efficiency and image compactness are obtained, and a high-quality image is formed. The shape factor SF1 is more preferably from 110 to 130.

The shape factor SF1 is obtained by the following expression (2).

SF1=(ML²/A)×(π/4)×100 Expression (2):

In Expression (2), ML represents a maximum length of a toner particle, and A represents a projected area of a toner particle.

Specifically, the shape factor SF1 is quantified by analyzing an optical microscopic image or a scanning electron microscopical image of the toner using an image analyzer, and calculated for example as follows. That is, a microscopic image of the toner sprayed on a surface of a glass slide is taken in a Luzex image analyzer through a video camera, maximum lengths (ML) and projected areas (A) of 100 toner particles are measured, SF1 of each toner particle is calculated through the above-described Expression (2), and an average of SF1 of the 100 toner particles is calculated to obtain the shape factor SF1.

Toner Manufacturing Method

A toner manufacturing method of this exemplary embodiment is not particularly limited. For example, cores of toner particles are prepared through a dry method such as a kneading pulverization manufacturing method or a wet method such as an aggregation coalescence method or a suspension polymerization method, shells containing a vinyl polymer are formed on surfaces of the cores to obtain toner particles, and then for example, an external additive is externally added to the toner particles to prepare a toner.

An aggregation coalescence method is preferable as a core preparation method. It is thought that cores prepared through the aggregation coalescence method have a larger amount of a release agent near surfaces of the cores than cores prepared through another method, and the size of the release agent particle in the core may be increased to some extent. Therefore, it is thought that the release agent easily seeps at the time of fixing a toner image and image deletion is more difficult to occur.

As a method of forming the shell containing a vinyl polymer on the surface of the core, a method of forming a shell by polymerizing vinyl monomers in a solvent is preferable.

For example, when cores and vinyl monomers are mixed up with each other and subjected to melting and kneading to polymerize the vinyl monomers and a shell is thus formed, it is thought that the vinyl polymer is relatively strongly adhered to surfaces of the cores. On the other hand, when the vinyl monomers are polymerized in a solvent to form a shell, it is thought that the vinyl polymer is relatively loosely adhered to the surfaces of the cores. Thus, it is thought that the release agent and the polyester easily seep at the time of fixing a toner image and image deletion is more difficult to occur.

Hereinafter, a method of preparing cores by the aggregation coalescence method and a shell forming method will be described.

Aggregation Coalescence Method

The aggregation coalescence method includes an aggregated particle forming process of forming, in a dispersion in which polyester that does not have an ethylenically unsaturated bond, a release agent, and a colorant are dispersed, aggregated particles containing the polyester, the release agent, and the colorant, and a coalescence process of coalescing the aggregated particles by heating the dispersion in which the aggregated particles are dispersed, thereby forming coalesced particles.

Specifically, for example, the aggregation coalescence method includes:

a process (dispersion preparation process) in which dispersions (resin particle dispersion, release agent dispersion, colorant dispersion, and the like) in which materials constituting a core are dispersed in dispersion solvents, respectively, are prepared,

a process (aggregated particle forming process) in which a mixed dispersion is obtained by mixing the above-described dispersions, and then an aggregating agent is added to the dispersion to form aggregated particles containing the materials constituting a core, and

a process (coalescence process) in which an aggregated particle dispersion in which the aggregated particles are dispersed is heated to coalesce the aggregated particles, thereby forming coalesced particles.

Hereinafter, each process will be described in detail.

Dispersion Preparation Process

In the dispersion preparation process, emulsified dispersions in which major materials constituting toner particles are dispersed in dispersion solvents, respectively, are prepared. Hereinafter, a resin particle dispersion, a release agent dispersion, a colorant dispersion, and the like will be described.

Resin Particle Dispersion

The resin particle dispersion may be prepared by giving a shearing force to a solution obtained by mixing a dispersion solvent and a resin by a disperser. In this case, particles may be formed by reducing the viscosity of the resin through heating. A dispersant may be used in order to stabilize the dispersed resin particles.

The dispersion solvent that is used in the resin particle dispersion and other dispersions may be an aqueous solvent. Examples of the aqueous solvent include water and alcohols.

When the resin has oiliness and is dissolved in a solvent having relatively low solubility to water, the resin may be dissolved in the solvent and then dispersed with a dispersant or a polyelectrolyte in water, and then heating or decompression may be performed to evaporate the solvent.

In this exemplary embodiment, a surfactant may be added to the aqueous solvent.

Examples of the surfactant include anionic surfactants such as sulfate ester salt-based, sulfonate-based, phosphate ester-based, and soap-based anionic surfactants; cationic surfactants such as amine salt-based and quaternary ammonium salt-based cationic surfactants; and nonionic surfactants such as polyethylene glycol-based, alkyl phenol ethylene oxide adduct-based, and polyol-based nonionic surfactants. Among them, anionic surfactants and cationic surfactants are preferable. Nonionic surfactants may be used in a combination of anionic surfactants or cationic surfactants.

Specific examples of the anionic surfactants include sodium dodecylbenzenesulfonate, sodium dodecyl sulfate, sodium alkylnaphthalenesulfonate, and sodium dialkylsulfosuccinate. Examples of the cationic surfactants include alkylbenzenedimethylammonium chloride, alkyltrimethylammonium chloride, and distearylammonium chloride.

The surfactant may be used singly or in a combination of two or more types.

The polyester resin contains functional groups that may become an anionic form by neutralization, and thus has self-water dispersibility and forms a water dispersion that is stable under the action of an aqueous solvent and in which some or all of the functional groups that may be hydrophilic are neutralized with a base.

The functional group that may be a hydrophilic group by neutralization in the polyester resin is an acidic group such as a carboxylic group or a sulfonate group. Examples of the neutralizer include inorganic alkalis such as potassium hydroxide and sodium hydroxide and amines such as ammonia, monomethylamine, dimethylamine, trimethylamine, monoethylamine, diethylamine, triethylamine, mono-n-propylamine, dimethyl-n-propylamine, monoethanolamine, diethanolamine, triethanolamine, N-methylethanolamine, N-aminoethylethanolamine, N-methyldiethanolamine, monoisopropanolamine, diisopropanolamine, triisopropanolamine, and N,N-dimethylpropanolamine. The pH during the emulsification is controlled to be neutral by adding such a neutralizer, thereby preventing hydrolysis of the obtained polyester resin dispersion.

A phase inversion emulsification method may be used when preparing a resin particle dispersion of a polyester resin. The phase inversion emulsification method may also be used when preparing a resin particle dispersion of a resin other than the polyester resin. The phase inversion emulsification method is a method including dissolving a resin to be dispersed in a hydrophobic organic solvent in which the resin is soluble, adding a base to an organic continuous phase (O-phase) to carry out neutralization, and adding an aqueous solvent (W-phase) to carry out resin conversion (so-called phase inversion) from W/O to O/W, thereby forming a discontinuous phase and stably dispersing the resin in a particle form in the aqueous solvent.

Examples of the organic solvent that is used in the phase inversion emulsification include alcohols such as ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, and cyclohexanol, ketones such as methyl ethyl ketone, methyl isobutyl ketone, ethyl butyl ketone, cyclohexanone, and isophorone, ethers such as tetrahydrofuran, dimethyl ether, diethyl ether, and dioxane, esters such as methyl acetate, ethyl acetate, n-propyl acetate, isopropyl acetate, n-butyl acetate, isobutyl acetate, sec-butyl acetate, 3-methoxybutyl acetate, methyl propionate, ethyl propionate, butyl propionate, dimethyl oxalate, diethyl oxalate, dimethyl succinate, diethyl succinate, diethyl carbonate, and dimethyl carbonate, glycol derivatives such as ethylene glycol, ethylene glycol monomethyl ether, ethylene glycol monoethyl ether, ethylene glycol monopropyl ether, ethylene glycol monobutyl ether, ethylene glycol ethyl ether acetate, diethylene glycol, diethylene glycol monomethyl ether, diethylene glycol monoethyl ether, diethylene glycol monopropyl ether, diethylene glycol monobutyl ether, diethylene glycol ethyl ether acetate, propylene glycol, propylene glycol monomethyl ether, propylene glycol monopropyl ether, propylene glycol monobutyl ether, propylene glycol methyl ether acetate, and dipropylene glycol monobutyl ether, 3-methoxy-3-methylbutanol, 3-methoxybutanol, acetonitrile, dimethylformamide, dimethylacetamide, diacetone alcohol, and ethyl acetoacetate. These solvents may be used singly or in a combination of two or more types.

It is difficult to universally determine the amount of the organic solvent that is used for the phase inversion emulsification, since the solvent amount for obtaining a desired dispersed particle size varies with the physical properties of the resin. However, in the exemplary embodiment, when the content of a tin compound catalyst in the resin is larger than that in a general polyester resin, the solvent amount with respect to the weight of the resin may be relatively large. When the solvent amount is small, the emulsification property may become poor, thereby increasing the particle size or broadening the particle size distribution of the resin particles.

A dispersant may be added in order to stabilize the dispersed particles and prevent an increase of the viscosity of the aqueous solvent in the phase inversion emulsification. Examples of the dispersant include water-soluble polymers such as polyvinyl alcohol, methyl cellulose, ethyl cellulose, hydroxyethyl cellulose, carboxymethyl cellulose, sodium polyacrylate, and sodium polymethacrylate, surfactants, e.g., anionic surfactants such as sodium dodecylbenzenesolfonate, sodium octadecylsulfate, sodium oleate, sodium laurate, and potassium stearate, cationic surfactants such as laurylamine acetate, stearylamine acetate, and lauryltrimethylammonium chloride, zwitterionic surfactants such as lauryldimethylamine oxide, nonionic surfactants such as polyoxyethylene alkyl ether, polyoxyethylene alkyl phenyl ether, and polyoxyethylene alkyl amine, and inorganic compounds such as tricalcium phosphate, aluminum hydroxide, calcium sulfate, calcium carbonate, and barium carbonate. These dispersants may be used singly or in a combination of two or more types. The dispersant may be added in an amount of from 0.01 part by weight to 20 parts by weight with respect to 100 parts by weight of the resin component.

In the phase inversion emulsification, the emulsification temperature is equal to or lower than the boiling point of the organic solvent and is equal to or higher than the melting temperature or the glass transition temperature of the resin component. When the emulsification temperature is lower than the melting temperature or the glass transition temperature of the resin component, it is difficult to prepare the resin particle dispersion. When the emulsification is performed at a temperature equal to or higher than the boiling point of the organic solvent, the emulsification may be performed in a pressure-sealed device.

Generally, the content of the resin particles contained in the resin particle dispersion is preferably from 5% by weight to 50% by weight, and more preferably from 10% by weight to 40% by weight. When the content is in the above range, the particle size distribution of the resin particles is difficult to expand.

The volume average particle size of the resin particles contained in the resin particle dispersion is, for example, preferably from 0.01 μm to 1 μm, more preferably from 0.03 μm to 0.8 μm, and even more preferably from 0.03 μm to 0.6 μm.

When the volume average particle size of the resin particles is in the above range, the finally obtained toner has a particle size distribution that is not too wide, whereby free particles are not easily generated and excellent performance and reliability are obtained. In addition, composition unevenness between toners is reduced, and a variation in the performance and reliability is reduced.

The volume average particle size of the particles such as the resin particles contained in the dispersion is measured using a laser diffraction-type particle size distribution measuring device (manufactured by Horiba, Ltd., LA-700).

Release Agent Dispersion

The release agent dispersion is prepared by: dispersing the release agent in water together with an ionic surfactant or the like; heating the dispersion to a temperature equal to or higher than the melting temperature of the release agent; and applying a strong shearing force using a homogenizer or a pressure discharge-type disperser. As a result, release agent particles having a volume average particle size of 1 μm or less (preferably from 0.1 μm to 0.5 μm) are dispersed in a dispersion solvent. As the dispersion solvent in the release agent dispersion, the same dispersion solvent as that used in the dispersion of the resin may be used.

Colorant Dispersion

For example, a common dispersing method using a rotary shearing-type homogenizer, a ball mill having a medium, a sand mill, a dyno-mill, or the like may be used as a dispersing method in the preparation of the colorant dispersion. Otherwise, an aqueous dispersion of the colorant may be prepared using a surfactant, or an organic solvent dispersion of the colorant may be prepared using a dispersant. As the surfactant or the dispersant used in the dispersion, the same dispersant as that may be used when dispersing the binder resin may be used.

Generally, the content of the colorant that is contained in the colorant dispersion is preferably from 5% by weight to 50% by weight, and more preferably from 10% by weight to 40% by weight. When the content is in the above range, the particle size distribution of the colorant particles is difficult to expand.

The volume average particle size of the particles contained in the colorant dispersion is preferably 2 μm or less, more preferably from 0.2 μm to 1.5 μm, and even more preferably from 0.3 μm to 1 μm.

A known device may be used as a device that mixes the resin, the colorant, and the like with a dispersion solvent, and emulsifies and disperses the dispersion. Examples thereof include continuous emulsification dispersers such as a homomixer (Primix Corporation), a slasher (Mitsui Mining Co., Ltd.), a cavitron (Eurotec, Ltd.), a microfluidizer (Mizuho Industrial Co., Ltd.), a Manton Gaulin homogenizer (Gaulin Co., Ltd.), a nanomizer (Nanomizer Inc.), and a static mixer (Noritake Co., Ltd).

The release agent and other internal additives may be dispersed in the resin dispersion.

Aggregated Particle Forming Process

In the aggregated particle forming process, in a dispersion in which polyester that does not have an ethylenically unsaturated bond, a release agent, and a colorant are dispersed, aggregated particles containing the polyester, the release agent, and the colorant are formed.

This process may be, for example, a process of forming aggregated particles including adding an aggregating agent to a mixed dispersion that is obtained by mixing the release agent dispersion, the colorant dispersion, and other dispersions with the resin particle dispersion, and generally heating the mixed dispersion to aggregate the particles in the mixed dispersion.

In the preparation of the mixed dispersion, the colorant dispersion may be mixed once together with other dispersions, or may be added and mixed in multiple stages.

The aggregated particles are formed by, for example: adding an aggregating agent at room temperature under stirring of the mixed dispersion with a rotary shearing-type homogenizer; adjusting the pH of the mixed dispersion to acidic; and heating the mixed dispersion to aggregate the particles dispersed in the mixed dispersion.

When the resin particles are a crystalline resin such as crystalline polyester, the mixed dispersion is heated to, for example, a temperature that is near the melting temperature of the crystalline resin (±20° C.) and is equal to or lower than the melting temperature.

In order to suppress rapid aggregation of the particles by heating, the pH may be adjusted in the stirring and mixing step at room temperature and a dispersion stabilizer may be added.

In this exemplary embodiment, the “room temperature” is 25° C.

A surfactant having an opposite polarity of the surfactant that is used as a dispersant to be added to the raw material dispersion, that is, an inorganic metal salt or a di- or higher-valent metal complex is preferably used as the aggregating agent that is used in the aggregated particle forming process. Particularly, when a metal complex is used, the amount of the surfactant used may be reduced and charging characteristics are improved.

In addition, an additive may be used that forms a complex or a similar bond with metal ions of the aggregating agent. A chelating agent is preferably used as the additive.

Examples of the inorganic metal salt that may be used as the aggregating agent include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide. Among them, aluminum salts and polymers thereof are preferable. In order to obtain a narrower particle size distribution, the valence of the inorganic metal salt is suitably divalent rather than monovalent, trivalent rather than divalent, and tetravalent rather than trivalent. Even with the same valence, a polymerization-type inorganic metal salt polymer is more suitable.

A water-soluble chelating agent may be used as the chelating agent. Since a water-insoluble chelating agent has poor dispersibility in the mixed dispersion solution, trapping of metal ions due to the aggregating agent may not be sufficient in the toner.

The chelating agent is not particularly limited as long as it is a known water-soluble chelating agent. For example, oxycarboxylic acids such as tartaric acid, citric acid, and gluconic acid, iminodiacetic acid (IDA), nitrilotriacetic acid (NTA), ethylenediaminetetraacetic acid (EDTA), or the like may be preferably used.

The amount of the chelating agent added is preferably from 0.01 part by weight to 5.0 parts by weight, and more preferably from 0.1 part by weight to less than 3.0 parts by weight with respect to 100 parts by weight of the resin component. When the amount of the chelating agent added is in the above range, the effect of addition of the chelating agent is exhibited, and it is difficult to affect viscoelasticity and a charging property of the toner.

The chelating agent is added during, before or after the aggregated particle forming process. The chelating agent may be added at room temperature without adjusting the temperature of the mixed dispersion, or may be added after adjusting the temperature to the inside temperature of the vessel in the aggregated particle forming process.

In the aggregated particle forming process, a resin particle dispersion may be added to the mixed dispersion in which the aggregated particles are formed, to adhere the resin particles to surfaces of the aggregated particles. As a result, toner particles having a so-called core-shell structure are obtained.

Generally, the major purpose of the core-shell structure is to, by covering a core containing a release agent and a crystalline resin with an amorphous resin shell layer, suppress the release agent and the crystalline resin contained in the core from being exposed to the surfaces of the toner particles. In addition, the core-shell structure is to compensate the strength when the strength of the core is insufficient.

Although the coalescence process is carried out after the aggregated particle forming process, the shell structure may be formed in multiple stages by alternately repeatedly carrying out the addition of the resin particle dispersion and the coalescence process.

Coalescence Process

In the coalescence process, for example, the pH of the aggregated particle dispersion containing the aggregated particles is adjusted to the range of from 6.5 to 8.5 to stop the progression of the aggregation, and then heating is performed to coalesce the aggregated particles, thereby obtaining coalesced particles (cores). The aggregated particles may be coalesced by performing the heating at a temperature equal to or higher than the melting temperature of the resin.

Shell Forming Method

A method of forming a shell includes by polymerizing vinyl monomers in a dispersion containing a core.

For example, the shell forming method includes:

a process (adhering process) in which a core dispersion containing core particles is mixed with a polymerizable component containing vinyl monomers to adhere the polymerizable component to the surface of the core particles, and

a process (polymerization process) of polymerizing the vinyl monomers contained in the polymerizable component to form a shell containing a polymer of the vinyl monomers on the surface of the core particles.

The core may be a core prepared through a dry method such as a kneading pulverization manufacturing method, or a core (coalesced particles) prepared through a wet method such as an aggregation coalescence method.

As the core dispersion, for example, a core (coalesced particles) dispersion prepared through the aggregation coalescence method may be used as is, or the core dispersion may be prepared by dispersing cores (kneaded and pulverized material) prepared through the kneading pulverization manufacturing method in a dispersion solvent. The dispersion solvent may be an aqueous solvent, or the same dispersion solvent as that used in the dispersion of the resin in the aggregation coalescence method may be used.

The polymerizable component may be, for example, a dispersion in which vinyl monomers are dispersed in a dispersion solvent, a solution in which vinyl monomers and an organic solvent are mixed with each other, or vinyl monomers themselves.

The dispersion of the vinyl monomers may be prepared by: mixing vinyl monomers with an aqueous solvent (for example, water containing a surfactant); and giving a shearing force by a disperser. The same aqueous solvent, surfactant, and disperser as those used in the dispersion of the resin in the aggregation coalescence process may be used.

Examples of the organic solvent that is used in the preparation of the polymerizable component include alcohol organic solvents, aliphatic organic solvents, and aromatic organic solvents. The proportion of the organic solvent in the polymerizable component is preferably from 5.0% by weight to 10.0% by weight from the viewpoint of adjusting the viscosity of the polymerizable component.

A polymerization initiator may be added to the polymerizable component.

Examples of the water-soluble polymerization initiator include peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, tert-butyl hydroperoxide pertriphenylacetate, tert-butyl performate, tert-butyl peracetate, tert-butyl perbenzoate, tert-butyl perphenylacetate, tert-butyl permethoxyacetate, tert-butyl per-N-(3-toluoyl)carbamate, ammonium bisulfate, and sodium bisulfate.

Examples of the oil-soluble polymerization initiator include azo polymerization initiators such as 2,2′-azobisisobutyronitrile, 2,2′-azobis(2,4-dimethylvaleronitrile), 1,1′-azobis(cyclohexane-1-carbonitrile), and 2,2′-azobis-4-methoxy-2,4-dimethylvaleronitrile.

The polymerization initiator may be added to the core dispersion.

The method of mixing the core dispersion with the polymerizable component is not particularly limited. For example, the mixing may be gradually continuously performed, or may be performed in multiple stages.

Conditions for adhering the polymerizable component to the surface of the core include, for example, heating during the stirring of the core dispersion, addition of the polymerization initiator, and subsequent addition of the polymerizable component.

The polymer may be formed under conditions of, for example, a reaction temperature of from 50° C. to 100° C. (preferably from 60° C. to 90° C.) and a reaction time of from 30 minutes to 5 hours (preferably from 1 hour to 4 hours).

In the polymerization process, a polymerizable component containing a polymerization initiator added thereto may be used, the core dispersion and the polymerizable component may be mixed in a state in which the polymerization initiator is added to the core dispersion in advance, the polymerization initiator may be added after mixing the core dispersion with the polymerizable component, or the polymerization initiator may be added to the reaction system with a method other than the above methods.

As a way to form a shell on the surface of the core so as to satisfy the above Expression (1), controlling: a ratio between the amount of core and the amount of vinyl monomers; a rate at which the polymerizable component is added to the core dispersion; a surfactant amount in the core dispersion; a temperature of the solvent at the time of polymerization of the vinyl monomers, and the like is exemplified.

In the above description, the method of forming a shell in a solvent has been described. However, a shell containing a vinyl polymer may be formed on the surface of the core by another method.

For example, a method of obtaining toner particles including: mixing cores, vinyl monomers, and a polymerization initiator; melting and kneading the mixture; cooling the melted and kneaded material; pulverizing the cooled material; and adhering the vinyl polymer to surfaces of the cores is exemplified.

Toner particles are obtained through the above processes. Thereafter, dried toner particles are obtained through a washing process, a solid-liquid separation process, and a drying process.

In the washing process, after removal of the dispersant adhered to the toner particles with an aqueous solution of a strong acid such as hydrochloric acid, sulfuric acid, and nitric acid, washing is preferably performed with ion exchange water until the filtrate becomes neutral.

The solid-liquid separation process is preferably suction filtration, pressure filtration, or the like in consideration of productivity.

Freeze drying, flash jet drying, fluidized drying, vibration-type fluidized drying, or the like is preferable as the drying process from the viewpoint of productivity. In the drying process, the water content of the toner particles after the drying may be adjusted to preferably 1.0% by weight or less, and more preferably 0.5% by weight or less.

The toner according to this exemplary embodiment is manufactured by, for example, adding and mixing an external additive with the obtained dried toner particles. The mixing may be performed using, for example, a V-blender, a Henschel mixer, a Lodige mixer, or the like.

The amount of the external additive added is preferably from 0.1 part by weight to 5 parts by weight, and more preferably from 0.3 part by weight to 2 parts by weight with respect to 100 parts by weight of the toner particles.

Furthermore, coarse toner particles may be removed using an ultrasonic sieving machine, a vibration sieving machine, a wind power sieving machine, or the like.

Electrostatic Charge Image Developer

An electrostatic charge image developer (hereinafter, also referred to as “developer”) of this exemplary embodiment includes at least the toner of this exemplary embodiment.

The toner of this exemplary embodiment is used as is as a single-component developer, or a two-component developer. When it is used as a two-component developer, it is used after being mixed with a carrier.

The carrier that may be used in the two-component developer is not particularly limited, and a known carrier may be used. Examples thereof include magnetic metals such as iron oxide, nickel, and cobalt, magnetic oxides such as ferrite and magnetite, resin-coated carriers having a resin coating layer on surfaces of the core materials, and magnetic dispersion-type carriers. In addition, resin dispersion-type carriers in which a conductive material and the like are dispersed in a matrix resin may also be used.

The types of the coating resin and the matrix resin constituting the carrier are not particularly limited. Examples thereof include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylic acid copolymers, straight silicone resins having organosiloxane bonds and modified products thereof, fluororesins, polyesters, polycarbonates, phenol resins, epoxy resins, (meth)acrylic resins, and dialkylaminoalkyl (meth)acrylic resins. Among them, dialkylaminoalkyl (meth)acrylic resins are preferable in consideration of the height of the charge amount and the like.

Examples of the conductive material include metals such as gold, silver, and copper, carbon black, titanium oxide, zinc oxide, tin oxide, barium sulfate, aluminum borate, and potassium titanate.

Examples of the core material of the carrier include magnetic metals such as iron, nickel, and cobalt, magnetic oxides such as ferrite and magnetite, and glass beads.

When the carrier is used in a magnetic brush method, the core material is preferably a magnetic material.

The volume average particle size of the core material of the carrier is, for example, from 10 μm to 500 μm, and preferably from 30 μm to 100 μm.

As a method of coating the surface of the core material with a resin, a coating method using a coating layer forming solution obtained by dissolving a coating resin and various additives in an appropriate solvent is exemplified.

Specific examples thereof include a dipping method of dipping a core material in a coating layer forming solution, a spray method of spraying a coating layer forming solution to a surface of a core material, a fluid bed method of spraying a coating layer forming solution in a state in which a core material is allowed to float with flowing air, and a kneader-coater method in which a core material and a coating layer forming solution are mixed with each other in a kneader-coater and a solvent is removed.

The solvent for the coating layer forming solution is not particularly limited, and may be selected in view of the type of the coating resin used, coatability, and the like.

The mixing ratio (weight ratio) between the toner and the carrier in the two-component developer is preferably from 1:100 to 30:100 (toner:carrier), and more preferably from 3:100 to 20:100.

Image Forming Apparatus and Image Forming Method

An image forming apparatus of this exemplary embodiment is provided with an image holding member, a charging unit that charges a surface of the image holding member, an electrostatic charge image forming unit that forms an electrostatic charge image on a charged surface of the image holding member, a developing unit that develops the electrostatic charge image formed on the surface of the image holding member with the developer of this exemplary embodiment to form a toner image, a transfer unit that transfers the toner image onto a recording medium, and a fixing unit that fixes the toner image to the recording medium.

The image forming apparatus of this exemplary embodiment performs an image forming method of this exemplary embodiment including: charging a surface of an image holding member, forming an electrostatic charge image on a charged surface of the image holding member, developing the electrostatic charge image with the developer of this exemplary embodiment to form a toner image, transferring the toner image onto a recording medium, and fixing the toner image to the recording medium.

In the image forming apparatus of this exemplary embodiment, for example, a part including the developing unit may have a cartridge structure (process cartridge) that is detachable from the body of the image forming apparatus. As the process cartridge, a process cartridge of this exemplary embodiment that accommodates the developer of this exemplary embodiment, is provided with a developing unit that develops an electrostatic charge image formed on a surface of an image holding member with the developer to form a toner image, and is detachably mounted on the image forming apparatus is preferably used.

Hereinafter, an example of the image forming apparatus of this exemplary embodiment will be shown. However, this exemplary embodiment is not limited thereto. Major parts shown in the drawings will be described, and descriptions of other parts will be omitted.

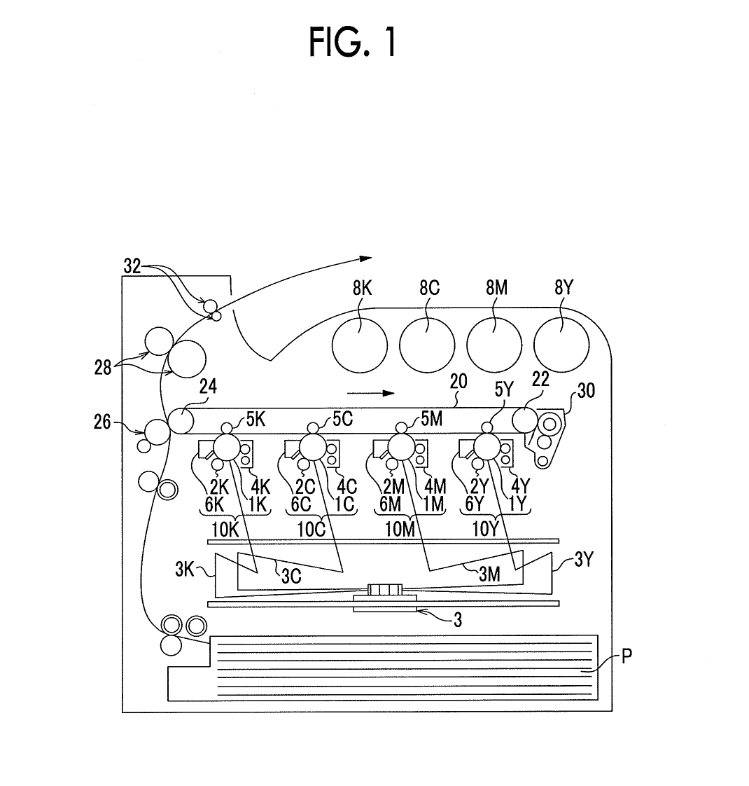

FIG. 1 is a schematic diagram showing a configuration of a four-drum tandem-type color image forming apparatus. The image forming apparatus shown in FIG. 1 is provided with first to fourth electrophotographic image forming units 10Y, 10M, 10C, and 10K (image forming units) that output yellow (Y), magenta (M), cyan (C), and black (K) images based on color-separated image data. These image forming units (hereinafter, may be simply referred to as “units”) 10Y, 10M, 10C, and 10K are arranged side by side at predetermined intervals in a horizontal direction. These units 10Y, 10M, 10C, and 10K may be process cartridges that are detachable from the body of the image forming apparatus.

An intermediate transfer belt 20 as an intermediate transfer member is installed above the units 10Y, 10M, 10C, and 10K in the drawing to extend through the units. The intermediate transfer belt 20 is wound on a driving roller 22 and a support roller 24 contacting the inner surface of the intermediate transfer belt 20 and travels in a direction toward the fourth unit 10K from the first unit 10Y. The support roller 24 is pushed in a direction in which it departs from the driving roller 22 by a spring or the like (not shown), and a predetermined tension is given to the intermediate transfer belt 20 wound on both of the rollers. In addition, an intermediate transfer member cleaning device 30 opposed to the driving roller 22 is provided on a surface of the intermediate transfer belt 20 on the image holding member side.

Developing devices (developing units) 4Y, 4M, 4C, and 4K of the units 10Y, 10M, 10C, and 10K are supplied with four color toners, that is, a yellow toner, a magenta toner, a cyan toner, and a black toner accommodated in toner cartridges 8Y, 8M, 8C, and 8K, respectively.

The above-described first to fourth units 10Y, 10M, 10C, and 10K have the same configuration. Here, only the first unit 10Y that is disposed on the upstream side in a traveling direction of the intermediate transfer belt to form a yellow image will be representatively described. The same parts as in the first unit 10Y will be denoted by the reference numerals with magenta (M), cyan (C), and black (K) added instead of yellow (Y), and descriptions of the second to fourth units 10M, 10C, and 10K will be omitted.

The first unit 10Y has a photoreceptor 1Y acting as an image holding member. Around the photoreceptor 1Y, a charging roller 2Y that charges a surface of the photoreceptor 1Y to a predetermined potential, an exposure device 3 that exposes the charged surface with laser beams 3Y based on a color-separated image signal to form an electrostatic charge image, a developing device (developing unit) 4Y that supplies a charged toner to the electrostatic charge image to develop the electrostatic charge image, a primary transfer roller (primary transfer unit) 5Y that transfers the developed toner image onto the intermediate transfer belt 20, and a photoreceptor cleaning device (cleaning unit) 6Y that removes the toner remaining on the surface of the photoreceptor 1Y after primary transfer, are arranged in sequence.

The primary transfer roller 5Y is disposed inside the intermediate transfer belt 20 to be provided at a position opposed to the photoreceptor 1Y. Furthermore, bias supplies (not shown) that apply a primary transfer bias are connected to the primary transfer rollers 5Y, 5M, 5C, and 5K, respectively. The bias supplies change the transfer bias that is applied to each primary transfer roller under the control of a controller (not shown).

Hereinafter, an operation of forming a yellow image in the first unit 10Y will be described. First, before the operation, the surface of the photoreceptor 1Y is charged to a potential of about from −600 V to −800 V by the charging roller 2Y.

The photoreceptor 1Y is formed by stacking a photosensitive layer on a conductive base (volume resistivity at 20° C.: 1×10⁻⁶ Ωcm or less). This photosensitive layer typically has high resistance (that is about the same as the resistance of a general resin), but has a property in which when laser beams 3Y are applied, the specific resistance of a part irradiated with the laser beams changes. Accordingly, the laser beams 3Y are output to the surface of the charged photoreceptor 1Y via the exposure device 3 in accordance with image data for yellow sent from the controller (not shown). The laser beams 3Y are applied to the photosensitive layer on the surface of the photoreceptor 1Y, whereby an electrostatic charge image of a yellow print pattern is formed on the surface of the photoreceptor 1Y.

The electrostatic charge image is an image that is formed on the surface of the photoreceptor 1Y by charging, and is a so-called negative latent image, that is formed by applying the laser beams 3Y to the photosensitive layer so that the specific resistance of the irradiated part is lowered to cause charges to flow on the surface of the photoreceptor 1Y, charges stay on a part to which the laser beams 3Y are not applied.

The electrostatic charge image that is formed in this manner on the photoreceptor 1Y is rotated up to a predetermined development position with the travelling of the photoreceptor 1Y. The electrostatic charge image on the photoreceptor 1Y is formed as a visual image (developed image) at the development position by the developing device 4Y.

The yellow developer accommodated in the developing device 4Y is frictionally charged by being stirred in the developing device 4Y to have a charge with the same polarity (negative polarity) as the charge that is on the photoreceptor 1Y, and is thus held on the developer roll (developer holding member). By allowing the surface of the photoreceptor 1Y to pass through the developing device 4Y, the yellow toner is electrostatically adhered to the electrostatic charge image on the surface of the photoreceptor 1Y, whereby the electrostatic charge image is developed with the yellow toner. Next, the photoreceptor 1Y having the yellow toner image formed thereon travels continuously at a predetermined rate and the toner image developed on the photoreceptor 1Y is transported to a predetermined primary transfer position.

When the yellow toner image on the photoreceptor 1Y is transported to the primary transfer position, a predetermined primary transfer bias is applied to the primary transfer roller 5Y and an electrostatic force toward the primary transfer roller 5Y from the photoreceptor 1Y acts on the toner image, whereby the toner image on the photoreceptor 1Y is transferred onto the intermediate transfer belt 20. The transfer bias applied at this time has the opposite polarity (+) of the toner polarity (−), and is controlled to be, for example, about +10 μA in the first unit 10Y by the controller (not shown).

On the other hand, the toner remaining on the photoreceptor 1Y is removed and collected by the photoreceptor cleaning device 6Y.

The primary transfer biases that are applied to the primary transfer rollers 5M, 5C, and 5K of the second unit 10M and the subsequent units are also controlled in the same manner as in the case of the first unit.

In this manner, the intermediate transfer belt 20 onto which the yellow toner image is transferred in the first unit 10Y is sequentially transported through the second to fourth units 10M, 10C, and 10K, and the toner images of respective colors are superimposed to form a composite toner image.

The intermediate transfer belt 20 on which the four color toner images have been superimposed through the first to fourth units reaches a secondary transfer part which is configured by the intermediate transfer belt 20, the support roller 24 contacting the inner surface of the intermediate transfer belt 20, and a secondary transfer roller (secondary transfer unit) 26 disposed on the image holding surface side of the intermediate transfer belt 20. Meanwhile, recording paper (recording medium) P is supplied to a gap between the secondary transfer roller 26 and the intermediate transfer belt 20, which are brought into press-contact with each other, via a supply mechanism at a predetermined timing, and a predetermined secondary transfer bias is applied to the support roller 24. The transfer bias applied at this time has the same polarity (−) as the toner polarity (−), and an electrostatic force toward the recording paper P from the intermediate transfer belt 20 acts on the composite toner image, whereby the composite toner image on the intermediate transfer belt 20 is transferred onto the recording paper P. In this case, the secondary transfer bias is determined depending on the resistance detected by a resistance detector (not shown) that detects the resistance of the secondary transfer part, and is voltage-controlled.

Thereafter, the recording paper P is fed to a fixing device (fixing unit) 28 to heat the composite toner image, and the color-superimposed toner image is melted and fixed to the recording paper P. The recording paper P on which the fixing of the color image has been completed is transported toward a discharge part by a transport roll (discharge roll) 32, and a series of the color image forming operations ends.

The image forming apparatus exemplified as above has a configuration in which the composite toner image is transferred onto the recording paper P via the intermediate transfer belt 20. However, the invention is not limited to this configuration, and may have a structure in which the toner image is transferred directly onto the recording paper from the photoreceptor.

Process Cartridge and Toner Cartridge

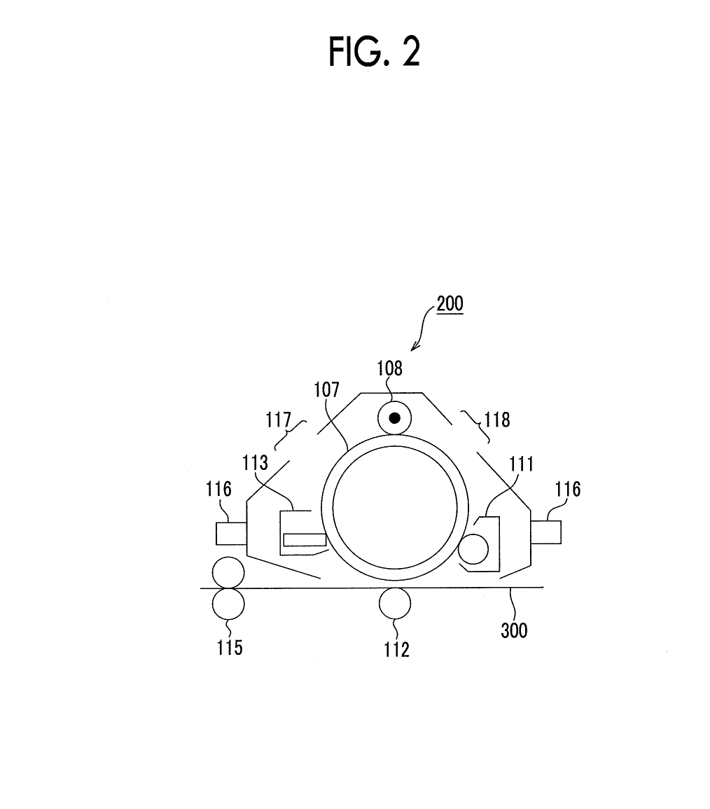

FIG. 2 is a schematic diagram showing the configuration of a preferable example of a process cartridge that accommodates the developer of this exemplary embodiment. A process cartridge 200 has, in addition to a photoreceptor 107, a charging device 108, a developing device 111, a photoreceptor cleaning device (cleaning unit) 113, an opening 118 for exposure, and an opening 117 for erasing exposure, and they are combined and integrated using an attachment rail 116.

The process cartridge 200 is detachably mounted on the body of an image forming apparatus configured by a transfer device 112, a fixing device 115, and other constituent parts (not shown), and constitutes the image forming apparatus together with the body of the image forming apparatus. The reference numeral 300 denotes recording paper.

The process cartridge 200 shown in FIG. 2 is provided with the photoreceptor 107, the charging device 108, the developing device 111, the photoreceptor cleaning device 113, the opening 118 for exposure, and the opening 117 for erasing exposure, but these devices may be selectively combined. The process cartridge of this exemplary embodiment may be provided with, as well as the developing device 111, at least one selected from the group consisting of the photoreceptor 107, the charging device 108, the photoreceptor cleaning device 113, the opening 118 for exposure, and the opening 117 for erasing exposure.

Next, a toner cartridge will be described.

The toner cartridge is detachably mounted on an image forming apparatus, and at least, in a toner cartridge that accommodates a toner for being supplied to a developing unit provided in the image forming apparatus, the above toner is the above-described toner of this exemplary embodiment. It is sufficient that the toner cartridge accommodates at least a toner, and for example, a developer may be accommodated according to the mechanism of the image forming apparatus.

The image forming apparatus shown in FIG. 1 is an image forming apparatus that has a configuration in which the toner cartridges 8Y, 8M, 8C, and 8K are detachable. The developing devices 4Y, 4M, 4C, and 4K are connected to the toner cartridges corresponding to the respective developing devices (colors) via developer supply pipes (not shown). In addition, when the developer that is accommodated in the toner cartridge runs low, the toner cartridge is replaced.

### EXAMPLES

Hereinafter, this exemplary embodiment will be described in more detail using examples and comparative examples, but is not limited to the following examples.

Unless specifically noted, “parts” and “%” are based on the weight.

Preparation of Resin Particle Dispersion

Preparation of Binder Resin Dispersion (A1)

Bisphenol-A Ethylene Oxide Adduct: 45.5 parts

Bisphenol-A Propylene Oxide Adduct: 26.7 parts

Terephthalic Acid: 22.9 parts

Dodecyl Succinic Anhydride: 4.1 parts

Succinic Acid: 10.8 parts

The above materials are put into a flask, and the temperature is increased to 200° C. over 4 hours. After it is confirmed that the reaction system is stirred well, 1.7 parts of dibutyltin oxide is put. Furthermore, while removing generated water, the temperature is increased from 200° C. to 230° C. over 6 hours to further continue the dehydration condensation reaction for 4 hours at 230° C., thereby obtaining an amorphous saturated polyester resin (A1) having a weight average molecular weight of 73,000.

Next, while being in a melt state, it is transferred to a cavitron CD1010 (manufactured by Eurotec, Ltd.) at a rate of 50 g/min. Diluted ammonia water having a concentration of 0.37% that is obtained by diluting reagent ammonia water with ion exchange water is put into a separately provided aqueous solvent tank, and transferred to the cavitron together with the polyester resin melt at a rate of 0.1 L/min while being heated at 97° C. with a heat exchanger. The cavitron is operated under conditions of a rotor rotation rate of 60 Hz and a pressure of 4 kg/cm², thereby obtaining a binder resin dispersion (A1) with a solid content of 38.1%.

Preparation of Binder Resin Dispersion (A2)

An amorphous saturated polyester resin (A2) having a weight average molecular weight of 71,000 is obtained in the same manner as in the synthesis of the amorphous saturated polyester resin (A1), except that 4.1 parts of the dodecyl succinic anhydride is changed to 4.3 parts of heptyl succinic anhydride.

Next, a binder resin dispersion (A2) with a solid content of 38.1% including the amorphous saturated polyester resin (A2) is obtained in the same manner as in the preparation of the binder resin dispersion (A1).

Preparation of Binder Resin Dispersion (A3)

An amorphous saturated polyester resin (A3) having a weight average molecular weight of 73,000 is obtained in the same manner as in the synthesis of the amorphous saturated polyester resin (A1), except that 4.1 parts of the dodecyl succinic anhydride is changed to 4.1 parts of octyl succinic anhydride.

Next, a binder resin dispersion (A3) with a solid content of 38.1% including the amorphous saturated polyester resin (A3) is obtained in the same manner as in the preparation of the binder resin dispersion (A1).

Preparation of Binder Resin Dispersion (A4)

An amorphous saturated polyester resin (A4) having a weight average molecular weight of 67,000 is obtained in the same manner as in the synthesis of the amorphous saturated polyester resin (A1), except that 4.1 parts of the dodecyl succinic anhydride is changed to 5.4 parts of octadecyl succinic anhydride.

Next, a binder resin dispersion (A4) with a solid content of 38.1% including the amorphous saturated polyester resin (A4) is obtained in the same manner as in the preparation of the binder resin dispersion (A1).

Preparation of Binder Resin Dispersion (A5)

An amorphous saturated polyester resin (A5) having a weight average molecular weight of 65,000 is obtained in the same manner as in the synthesis of the amorphous saturated polyester resin (A1), except that 4.1 parts of the dodecyl succinic anhydride is changed to 6.5 parts of nonadecyl succinic anhydride.

Next, a binder resin dispersion (A5) with a solid content of 38.1% including the amorphous saturated polyester resin (A5) is obtained in the same manner as in the preparation of the binder resin dispersion (A1).

Preparation of Binder Resin Dispersion (B1)

Bisphenol-A Ethylene Oxide Adduct: 50.1 parts

Bisphenol-A Propylene Oxide Adduct: 25.3 parts

Terephthalic Acid: 21.2 parts

Dodecyl Succinic Anhydride: 3.9 parts

Fumaric Acid: 10.2 parts

The above materials are put into a flask, and the temperature is increased to 200° C. over 4 hours. After it is confirmed that the reaction system is stirred well, 1.3 parts of dibutyltin oxide is put. Furthermore, while removing generated water, the temperature is increased from 200° C. to 250° C. over 5.5 hours to further continue the dehydration condensation reaction for 4 hours at 250° C., thereby obtaining an amorphous unsaturated polyester resin (B1) having a weight average molecular weight of 70,000.

Next, while being in a melt state, it is transferred to a cavitron CD1010 (manufactured by Eurotec, Ltd.) at a rate of 30 g/min. Diluted ammonia water having a concentration of 0.37% that is obtained by diluting reagent ammonia water with ion exchange water is put into a separately provided aqueous solvent tank, and transferred to the cavitron together with the polyester resin melt at a rate of 0.1 L/min while being heated at 97° C. with a heat exchanger. The cavitron is operated under conditions of a rotor rotation rate of 60 Hz and a pressure of 4 kg/cm², thereby obtaining a binder resin dispersion (B1) with a solid content of 37.2%.

Preparation of Binder Resin Dispersion (B2)

Styrene: 495 parts

n-Butyl Acrylate: 129 parts

Acrylic Acid: 16 parts

Dodecanethiol: 12 parts

A solution is prepared by mixing and dissolving the above materials. 12 parts of an anionic surfactant (Dowfax 2A1 manufactured by Dow Chemical Company) is dissolved in 321 parts of ion exchange water, and the solution is added thereto and dispersed and emulsified in a flask (monomer emulsion A). Furthermore, 1 part of an anionic surfactant (Dowfax 2A1 manufactured by Dow Chemical Company) is dissolved in 493 parts of ion exchange water and put into a separable flask. The separable flask is sealed airtight and a reflux pipe is installed. While injecting nitrogen, stirring is slowly performed, and the separable flask is heated to 75° C. using a water bath and held. 8 parts of ammonium persulfate is dissolved in 78 parts of ion exchange water and added dropwise over 15 minutes using a constant rate pump, and then the monomer emulsion A is also added dropwise over 200 minutes using the constant rate pump. Thereafter, while slowly continuing the stirring, the separable flask is held at 75° C. for 4 hours, and then the polymerization ends.

As a result, a binder resin dispersion (B2) with a solid content of 31.6% in which an amorphous polystyrene-acrylic resin (B2) having a weight average molecular weight of 28,000 is dispersed is obtained.

Preparation of Binder Resin Dispersion (C1)

Dimethyl Dodecanedioate: 159 parts

1,9-Nonanediol: 79 parts

The above materials are put into a flask, and the temperature is increased to 180° C. over 2.5 hours. After it is confirmed that the reaction system is stirred well, 0.5 part of titanium tetrabutoxide is put. Furthermore, while removing generated water, the temperature is increased from 180° C. to 220° C. over 2 hours to further continue the dehydration condensation reaction for 2 hours at 220° C., thereby obtaining a crystalline saturated polyester resin (C1) having a weight average molecular weight of 26,000 and a melting temperature Tc of 72° C.

Next, while being in a melt state, it is transferred to a cavitron CD1010 (manufactured by Eurotec, Ltd.) at a rate of 10 g/min. Diluted ammonia water having a concentration of 0.35% that is obtained by diluting reagent ammonia water with ion exchange water is put into a separately provided aqueous solvent tank, and transferred to the cavitron together with the polyester resin melt at a rate of 0.1 L/min while being heated at 85° C. with a heat exchanger. The cavitron is operated under conditions of a rotor rotation rate of 60 Hz and a pressure of 3 kg/cm², thereby obtaining a binder resin dispersion (C1) with a solid content of 26.1%.

The resin components contained in the respective binder resin dispersions are collectively shown in Table 1.

TABLE 1

| | | Number of | Weight | Melting |
|---|---|---|---|---|
| | | Carbon Atoms of | Average | Temperature |
| Binder Resin | | Side Chain of | Molecular | Tc |
| Dispersion | Resin Component | Long-Chain Alkyl | Weight | [° C.] |
| (A1) | Amorphous Saturated Polyester Resin (A1) | 12 | 73,000 | — |
| (A2) | Amorphous Saturated Polyester Resin (A2) | 7 | 71,000 | — |
| (A3) | Amorphous Saturated Polyester Resin (A3) | 8 | 73,000 | — |
| (A4) | Amorphous Saturated Polyester Resin (A4) | 18 | 67,000 | — |
| (A5) | Amorphous Saturated Polyester Resin (A5) | 19 | 65,000 | — |
| (B1) | Amorphous Unsaturated Polyester Resin (B1) | 12 | 70,000 | — |
| (B2) | Amorphous Polystyrene-Acrylic Resin (B2) | 4 | 28,000 | — |
| (C1) | Crystalline Saturated Polyester Resin (C1) | — | 26,000 | 72 |

Preparation of Colorant Dispersion

Preparation of Pigment Dispersion (1)

Carbon Black (NiPex 35 manufactured by Evonic Industries AG): 81 parts

Anionic Surfactant (Dowfax 2A1 manufactured by Dow Chemical Company): 10 parts

Ion Exchange Water: 210 parts

The above materials are mixed and dispersed for 30 minutes using a homogenizer (Ultra Turrax T50 manufactured by IKA-Werke Gmbh & Co. KG), and then dispersed using a circulation-type ultrasonic disperser (RUS-600 TCVP manufactured by Nippon Seiki Co., Ltd.), thereby preparing a pigment dispersion (1) with a solid content of 26.2%.

Preparation of Release Agent Dispersion

Preparation of Release Agent Dispersions (1) to (8)

The materials shown in Table 2 are mixed and dispersed for 20 minutes using a homogenizer (Ultra Turrax T50 manufactured by IKA-Werke Gmbh & Co. KG), and then dispersed using a circulation-type ultrasonic disperser (RUS-600 TCVP manufactured by Nippon Seiki Co., Ltd.), thereby preparing release agent dispersions (1) to (8). The solid contents of the respective release agent dispersions and the melting temperatures of the contained release agents are shown in Table 2.

The materials are as follows in detail.

HNP9: manufactured by Nippon Seiro Co., Ltd., Paraffin Wax

WEP-4: manufactured by NOF Corporation, Fatty Acid Ester

FNP0080: manufactured by Nippon Seiro Co., Ltd., Fischer-Tropsch Wax

WEP-5: manufactured by NOF Corporation, Fatty Acid Ester

FNP0090: manufactured by Nippon Seiro Co., Ltd., Paraffin Wax

PW655: manufactured by Toyo Petrolite Co., Ltd., Polyethylene Wax

FT100: manufactured by Nippon Seiro Co., Ltd., Fischer-Tropsch Wax

FT105: manufactured by Nippon Seiro Co., Ltd., Fischer-Tropsch Wax

Anionic Surfactant: Dowfax 2A1 manufactured by Dow Chemical Company

TABLE 2

| | Materials [parts by weight] | | | | | Melting |
|---|---|---|---|---|---|---|
| Release Agent | | | Anionic | Ion Exchange | Solid Content | Temperature Tw |
| Dispersion | Release Agent | | Surfactant | Water | [wt %] | [° C.] |
| (1) | HNP9 | 87 | 15 | 240 | 24.8 | 76 |
| (2) | WEP-4 | 90 | 15 | 230 | 28.4 | 74 |
| (3) | FNP0080 | 90 | 15 | 255 | 26.7 | 80 |
| (4) | WEP-5 | 90 | 15 | 340 | 21.7 | 84 |
| (5) | FNP0090 | 90 | 15 | 260 | 26.8 | 90 |
| (6) | PW655 | 90 | 15 | 292 | 24.4 | 94 |
| (7) | FT100 | 90 | 15 | 308 | 23.6 | 100 |
| (8) | FT105 | 90 | 15 | 252 | 27.6 | 103 |

Preparation of Carrier (1)

Ferrite Particles (volume average particle size: 35 μm): 100 parts

Toluene: 14 parts

Perfluorooctylethyl Acrylate-Methyl Methacrylate Copolymer (polymerization ratio: 2:8, weight average molecular weight: 77000, critical surface tension: 24 dyn/cm): 1.6 parts

Carbon Black (VXC-72 manufactured by Cabot Corporation, volume resistivity: 100 Ωcm or less): 0.12 part

Cross-Linked Melamine Resin Particles (average particle size: 0.3 μm, toluene-insoluble): 0.3 part

The carbon black dispersed in toluene is added to the perfluorooctylethyl acrylate-methyl methacrylate copolymer and dispersed with a sand mill. Next, the cross-linked melamine resin particles are added to this and stirring is performed for 10 minutes with a stirrer, thereby preparing a coating layer forming liquid. Next, the coating layer forming liquid and the ferrite particles are put into a vacuum deaeration-type kneader and stirred for 30 minutes at a temperature of 60° C. Then, the toluene is distilled away by decompression to form a resin coating layer, thereby obtaining a carrier (1).

### Example 1

### Preparation of Toner Particles (1)

Binder Resin Dispersion (A1): 153.5 parts

Binder Resin Dispersion (C1): 38.3 parts

Pigment Dispersion (1): 19.1 parts

Release Agent Dispersion (1): 28.2 parts

20%-Surfactant (Dowfax 2A1 manufactured by Dow Chemical Company): 7.0 parts

Ion Exchange Water: 1053.0 parts

The above materials are mixed in a round stainless-steel flask using a homogenizer (Ultra Turrax T50 manufactured by IKA-Werke Gmbh & Co. KG), and thus a dispersion is obtained. 42.1 parts of a 3%-aqueous aluminum sulfate solution is added to the dispersion and the content in the flask is stirred using a water bath with a stirring function. It is confirmed that the content in the flask is dispersed, and using a three-one motor (BLh300 manufactured by Shinto Scientific Co., Ltd.), the content is stirred at a stirring rotation rate of 150 rpm and then subjected to heating and stirring to 48.2° C. at a rate of temperature increase of 0.1° C./min. The obtained material is held for 240 minutes. Thereafter, 51.2 parts of the additional binder resin dispersion (A1) is added thereto and the resultant is stirred for 60 minutes. Next, 10.0 parts of a 10%-aqueous EDTA solution is added, and then the pH is adjusted to 8.5 with a 0.5 M-aqueous sodium hydroxide solution, thereby obtaining an aggregated particle dispersion.

Next, the temperature of the aggregated particle dispersion is increased to coalesce the aggregated particles over 6 hours at 80° C. The obtained material is cooled and then sufficiently washed with ion exchange water, thereby obtaining a core dispersion (1) that is a dispersion of core particles.

3.7 parts of a 20%-surfactant (Dowfax 2A1 manufactured by Dow Chemical Company), 1.0 part of potassium persulfate, and 0.5 part of sodium thiosulfate are added to the core dispersion (1). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (1) over 10 hours at an addition rate of 0.68 mL/min and the resultant is further stirred for 5 hours.

The obtained content is cooled, and then washed with ion exchange water and dried, thereby obtaining toner particles (1) in which the styrene polymer is generated on surfaces of the cores. The volume average particle size of the toner particles (1) is 6.0 μm.

Preparation of Toner (1)

3 parts of a fumed silica RX50 (manufactured by Nippon Aerosil Co., Ltd., number average particle size: 40 nm) as an external additive is added to 100 parts of the toner particles (1), and mixed therewith for 10 minutes at a circumferential velocity of 45 m/sec using a Henschel mixer. Then, coarse particles are removed using a sieve with a 45 μm-mesh, thereby obtaining a toner (1).

Preparation of Developer (1)

16.1 parts of the toner (1) and 213.9 parts of the carrier (1) are put into a V-blender of 2 L and stirred for 20 minutes. Next, the obtained material is sieved with a 212 μm-sieve, thereby obtaining a developer (1).

### Example 2

### Preparation of Toner Particles (2)

The core dispersion (1) of Example 1 is prepared.

1.0 part of potassium persulfate and 0.5 part of sodium thiosulfate are added to the core dispersion (1). While nitrogen substitution is carried out, these are subjected to heating and stirring to 36° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (1) over 17 hours at an addition rate of 0.40 mL/min and the resultant is further stirred for 5 hours.

The obtained content is cooled, and then washed with ion exchange water and dried, thereby obtaining toner particles (2) in which the styrene polymer is generated on surfaces of the cores. The volume average particle size of the toner particles (2) is 5.8 μm.

Preparation of Toner (2)

A toner (2) is obtained in the same manner as in the preparation of the toner (1), except that the toner particles (2) are used in place of the toner particles (1).

Preparation of Developer (2)

A developer (2) is obtained in the same manner as in the preparation of the developer (1), except that the toner (2) is used in place of the toner (1).

### Example 3

### Preparation of Toner Particles (3)

The core dispersion (1) of Example 1 is prepared.

3.8 parts of a 20%-surfactant (Dowfax 2A1 manufactured by Dow Chemical Company), 1.0 part of potassium persulfate, and 0.5 part of sodium thiosulfate are added to the core dispersion (1). While nitrogen substitution is carried out, these are subjected to heating and stirring to 38° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (1) over 8 hours at an addition rate of 0.84 mL/min and the resultant is further stirred for 5 hours.

The obtained content is cooled, and then washed with ion exchange water and dried, thereby obtaining toner particles (3) in which the styrene polymer is generated on surfaces of the cores. The volume average particle size of the toner particles (3) is 6.4

Preparation of Toner (3)

A toner (3) is obtained in the same manner as in the preparation of the toner (1), except that the toner particles (3) are used in place of the toner particles (1).

Preparation of Developer (3)

A developer (3) is obtained in the same manner as in the preparation of the developer (1), except that the toner (3) is used in place of the toner (1).

### Example 4

### Preparation of Toner Particles (4)

The core dispersion (1) of Example 1 is prepared.

9.0 parts of a 20%-surfactant (Dowfax 2A1 manufactured by Dow Chemical Company), 1.0 part of potassium persulfate, and 0.5 part of sodium thiosulfate are added to the core dispersion (1). While nitrogen substitution is carried out, these are subjected to heating and stirring to 32° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (1) over 19 hours at an addition rate of 0.36 mL/min and the resultant is further stirred for 5 hours.

The obtained content is cooled, and then washed with ion exchange water and dried, thereby obtaining toner particles (4) in which the styrene polymer is generated on surfaces of the cores. The volume average particle size of the toner particles (4) is 6.4 μm.

Preparation of Toner (4)

A toner (4) is obtained in the same manner as in the preparation of the toner (1), except that the toner particles (4) are used in place of the toner particles (1).

Preparation of Developer (4)

A developer (4) is obtained in the same manner as in the preparation of the developer (1), except that the toner (4) is used in place of the toner (1).

### Example 5

### Preparation of Toner Particles (5)

The core dispersion (1) of Example 1 is prepared.

4.1 parts of a 20%-surfactant (Dowfax 2A1 manufactured by Dow Chemical Company), 1.0 part of potassium persulfate, and 0.5 part of sodium thiosulfate are added to the core dispersion (1). While nitrogen substitution is carried out, these are subjected to heating and stirring to 28° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (1) over 7 hours at an addition rate of 0.96 mL/min and the resultant is further stirred for 5 hours.

The obtained content is cooled, and then washed with ion exchange water and dried, thereby obtaining toner particles (5) in which the styrene polymer is generated on surfaces of the cores. The volume average particle size of the toner particles (5) is 6.3 μm.

Preparation of Toner (5)

A toner (5) is obtained in the same manner as in the preparation of the toner (1), except that the toner particles (5) are used in place of the toner particles (1).

Preparation of Developer (5)

A developer (5) is obtained in the same manner as in the preparation of the developer (1), except that the toner (5) is used in place of the toner (1).

### Example 6

### Preparation of Toner Particles (6)

The core dispersion (1) of Example 1 is prepared.

9.0 parts of a 20%-surfactant (Dowfax 2A1 manufactured by Dow Chemical Company), 1.0 part of potassium persulfate, and 0.5 part of sodium thiosulfate are added to the core dispersion (1). While nitrogen substitution is carried out, these are subjected to heating and stirring to 32° C. at a rate of temperature increase of 0.1° C./min, and stirred for 120 minutes.

Separately, 7.0 parts of styrene and 400 parts of ion exchange water are mixed to prepare a styrene dispersion, and the styrene dispersion is added to the core dispersion (1) over 19 hours at an addition rate of 0.36 mL/min and the resultant is further stirred for 5 hours.

The obtained content is cooled, and then washed with ion exchange water and dried, thereby obtaining toner particles (6) in which the styrene polymer is generated on surfaces of the cores. The volume average particle size of the toner particles (6) is 6.4 μm.

Preparation of Toner (6)

A toner (6) is obtained in the same manner as in the preparation of the toner (1), except that the toner particles (6) are used in place of the toner particles (1).

Preparation of Developer (6)

A developer (6) is obtained in the same manner as in the preparation of the developer (1), except that the toner (6) is used in place of the toner (1).

### Example 7

### Preparation of Toner Particles (7)

Amorphous Saturated Polyester Resin (A1): 78.0 parts

Crystalline Saturated Polyester Resin (C1): 10.0 parts

Carbon Black (NiPex 35 manufactured by Evonic Industries AG): 5.0 parts

Release Agent (HNP9 manufactured by Nippon Seiro Co., Ltd., melting temperature: 76° C.): 7.0 parts

20%-Surfactant (Dowfax 2A1 manufactured by Dow Chemical Company): 7.0 parts

The above materials are heated to 85° C. and melted. Then, the obtained material is melted and kneaded with an extruder at a set temperature of 180° C., a screw rotation rate of 280 rpm, and a supply rate of 220 kg/hr. After cooling, coarse pulverization is performed, and then fine pulverization is performed with a jet mill. The pulverized material is subjected to air classification, thereby obtaining a kneaded and pulverized toner material (7).

1.0 part of a 20%-surfactant (Dowfax 2A1 manufactured by Dow Chemical Company) and 1053.0 parts of ion exchange water are added to the kneaded and pulverized toner material (7), and stirred at a stirring rotation rate of 350 rpm using a three-one motor (BLh300 manufactured by Shinto Scientific Co., Ltd.), thereby obtaining a core dispersion (7) that is a dispersion of cores.

1.0 part of a 20%-surfactant (Dowfax 2A1 manufactured by Dow Chemical Company), 1.0 part of potassium persulfate, and 0.5 part of sodium thiosulfate are added to the core dispersion (7). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (7) over 11 hours at an addition rate of 0.62 mL/min and the resultant is further stirred for 5 hours.

The obtained content is cooled, and then washed with ion exchange water and dried, thereby obtaining toner particles (7) in which the styrene polymer is generated on surfaces of the cores. The volume average particle size of the toner particles (7) is 6.0 μm.

Preparation of Toner (7)

A toner (7) is obtained in the same manner as in the preparation of the toner (1), except that the toner particles (7) are used in place of the toner particles (1).

Preparation of Developer (7)

A developer (7) is obtained in the same manner as in the preparation of the developer (1), except that the toner (7) is used in place of the toner (1).

### Example 8

### Preparation of Toner Particles (8)

Binder Resin Dispersion (A1): 173.2 parts

Pigment Dispersion (1): 19.1 parts

Release Agent Dispersion (1): 28.2 parts

20%-Surfactant (Dowfax 2A1 manufactured by Dow Chemical Company): 7.0 parts

Ion Exchange Water: 1053.0 parts

The above materials are mixed in a round stainless-steel flask using a homogenizer (Ultra Turrax T50 manufactured by IKA-Werke Gmbh & Co. KG), and thus a dispersion is obtained. 42.1 parts of a 3%-aqueous aluminum sulfate solution is added to the dispersion and the content in the flask is stirred using a water bath with a stirring function. It is confirmed that the content in the flask is dispersed, and using a three-one motor (BLh300 manufactured by Shinto Scientific Co., Ltd.), the content is stirred at a stirring rotation rate of 150 rpm and then subjected to heating and stirring to 48.2° C. at a rate of temperature increase of 0.1° C./min. The obtained material is held for 240 minutes. Thereafter, 57.7 parts of the additional binder resin dispersion (A1) is added thereto and the resultant is stirred for 60 minutes. Next, 10.0 parts of a 10%-aqueous EDTA solution is added, and then the pH is adjusted to 8.5 with a 0.5 M-aqueous sodium hydroxide solution, thereby obtaining an aggregated particle dispersion.

Next, the temperature of the aggregated particle dispersion is increased to coalesce the aggregated particles over 6 hours at 80° C. The obtained material is cooled and then sufficiently washed with ion exchange water, thereby obtaining a core dispersion (8) that is a dispersion of cores.

1.0 part of a 20%-surfactant (Dowfax 2A1 manufactured by Dow Chemical Company), 1.0 part of potassium persulfate, and 0.5 part of sodium thiosulfate are added to the core dispersion (8). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (8) over 11 hours at an addition rate of 0.62 mL/min and the resultant is further stirred for 5 hours.

The obtained content is cooled, and then washed with ion exchange water and dried, thereby obtaining toner particles (8) in which the styrene polymer is generated on surfaces of the cores. The volume average particle size of the toner particles (8) is 5.7 μm.

Preparation of Toner (8)

A toner (8) is obtained in the same manner as in the preparation of the toner (1), except that the toner particles (8) are used in place of the toner particles (1).

Preparation of Developer (8)

A developer (8) is obtained in the same manner as in the preparation of the developer (1), except that the toner (8) is used in place of the toner (1).

### Example 9

### Preparation of Toner Particles (9)

A core dispersion (9) is obtained in the same manner as in the preparation of the core dispersion (1) of Example 1, except that 28.2 parts of the release agent dispersion (1) is changed to 24.6 parts of a release agent dispersion (2).

1.0 part of a 20%-surfactant (Dowfax 2A1 manufactured by Dow Chemical Company), 1.0 part of potassium persulfate, and 0.5 part of sodium thiosulfate are added to the core dispersion (9). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (9) over 11 hours at an addition rate of 0.62 mL/min and the resultant is further stirred for 5 hours.

The obtained content is cooled, and then washed with ion exchange water and dried, thereby obtaining toner particles (9) in which the styrene polymer is generated on surfaces of the cores. The volume average particle size of the toner particles (9) is 6.4 μm.

Preparation of Toner (9)

A toner (9) is obtained in the same manner as in the preparation of the toner (1), except that the toner particles (9) are used in place of the toner particles (1).

Preparation of Developer (9)

A developer (9) is obtained in the same manner as in the preparation of the developer (1), except that the toner (9) is used in place of the toner (1).

### Example 10

### Preparation of Toner Particles (10)

A core dispersion (10) is obtained in the same manner as in the preparation of the core dispersion (1) of Example 1, except that 28.2 parts of the release agent dispersion (1) is changed to 26.2 parts of a release agent dispersion (3).

1.0 part of a 20%-surfactant (Dowfax 2A1 manufactured by Dow Chemical Company), 1.0 part of potassium persulfate, and 0.5 part of sodium thiosulfate are added to the core dispersion (10). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (10) over 11 hours at an addition rate of 0.62 mL/min and the resultant is further stirred for 5 hours.

The obtained content is cooled, and then washed with ion exchange water and dried, thereby obtaining toner particles (10) in which the styrene polymer is generated on surfaces of the cores. The volume average particle size of the toner particles (10) is 6.5 μm.

Preparation of Toner (10)

A toner (10) is obtained in the same manner as in the preparation of the toner (1), except that the toner particles (10) are used in place of the toner particles (1).

Preparation of Developer (10)

A developer (10) is obtained in the same manner as in the preparation of the developer (1), except that the toner (10) is used in place of the toner (1).

### Example 11

### Preparation of Toner Particles (11)

A core dispersion (11) is obtained in the same manner as in the preparation of the core dispersion (1) of Example 1, except that 28.2 parts of the release agent dispersion (1) is changed to 32.3 parts of a release agent dispersion (4).

1.0 part of a 20%-surfactant (Dowfax 2A1 manufactured by Dow Chemical Company), 1.0 part of potassium persulfate, and 0.5 part of sodium thiosulfate are added to the core dispersion (11). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (11) over 11 hours at an addition rate of 0.62 mL/min and the resultant is further stirred for 5 hours.

The obtained content is cooled, and then washed with ion exchange water and dried, thereby obtaining toner particles (11) in which the styrene polymer is generated on surfaces of the cores. The volume average particle size of the toner particles (11) is 5.7 μm.

Preparation of Toner (11)

A toner (11) is obtained in the same manner as in the preparation of the toner (1), except that the toner particles (11) are used in place of the toner particles (1).

Preparation of Developer (11)

A developer (11) is obtained in the same manner as in the preparation of the developer (1), except that the toner (11) is used in place of the toner (1).

### Example 12

### Preparation of Toner Particles (12)

A core dispersion (12) is obtained in the same manner as in the preparation of the core dispersion (1) of Example 1, except that 28.2 parts of the release agent dispersion (1) is changed to 26.1 parts of a release agent dispersion (5).

1.0 part of a 20%-surfactant (Dowfax 2A1 manufactured by Dow Chemical Company), 1.0 part of potassium persulfate, and 0.5 part of sodium thiosulfate are added to the core dispersion (12). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (12) over 11 hours at an addition rate of 0.62 mL/min and the resultant is further stirred for 5 hours.

The obtained content is cooled, and then washed with ion exchange water and dried, thereby obtaining toner particles (12) in which the styrene polymer is generated on surfaces of the cores. The volume average particle size of the toner particles (12) is 6.1 μm.

Preparation of Toner (12)

A toner (12) is obtained in the same manner as in the preparation of the toner (1), except that the toner particles (12) are used in place of the toner particles (1).

Preparation of Developer (12)

A developer (12) is obtained in the same manner as in the preparation of the developer (1), except that the toner (12) is used in place of the toner (1).

### Example 13

### Preparation of Toner Particles (13)

A core dispersion (13) is obtained in the same manner as in the preparation of the core dispersion (1) of Example 1, except that 28.2 parts of the release agent dispersion (1) is changed to 28.7 parts of a release agent dispersion (6).

1.0 part of a 20%-surfactant (Dowfax 2A1 manufactured by Dow Chemical Company), 1.0 part of potassium persulfate, and 0.5 part of sodium thiosulfate are added to the core dispersion (13). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (13) over 11 hours at an addition rate of 0.62 mL/min and the resultant is further stirred for 5 hours.

The obtained content is cooled, and then washed with ion exchange water and dried, thereby obtaining toner particles (13) in which the styrene polymer is generated on surfaces of the cores. The volume average particle size of the toner particles (13) is 5.6 μm.

Preparation of Toner (13) A toner (13) is obtained in the same manner as in the preparation of the toner (1), except that the toner particles (13) are used in place of the toner particles (1).

Preparation of Developer (13)

A developer (13) is obtained in the same manner as in the preparation of the developer (1), except that the toner (13) is used in place of the toner (1).

### Example 14

### Preparation of Toner Particles (14)

A core dispersion (14) is obtained in the same manner as in the preparation of the core dispersion (1) of Example 1, except that 28.2 parts of the release agent dispersion (1) is changed to 29.7 parts of a release agent dispersion (7).

1.0 part of a 20%-surfactant (Dowfax 2A1 manufactured by Dow Chemical Company), 1.0 part of potassium persulfate, and 0.5 part of sodium thiosulfate are added to the core dispersion (14). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (14) over 11 hours at an addition rate of 0.62 mL/min and the resultant is further stirred for 5 hours.

The obtained content is cooled, and then washed with ion exchange water and dried, thereby obtaining toner particles (14) in which the styrene polymer is generated on surfaces of the cores. The volume average particle size of the toner particles (14) is 5.7 μm.

Preparation of Toner (14)

A toner (14) is obtained in the same manner as in the preparation of the toner (1), except that the toner particles (14) are used in place of the toner particles (1).

Preparation of Developer (14)

A developer (14) is obtained in the same manner as in the preparation of the developer (1), except that the toner (14) is used in place of the toner (1).

### Example 15

### Preparation of Toner Particles (15)

A core dispersion (15) is obtained in the same manner as in the preparation of the core dispersion (1) of Example 1, except that 28.2 parts of the release agent dispersion (1) is changed to 25.4 parts of a release agent dispersion (8).

1.0 part of a 20%-surfactant (Dowfax 2A1 manufactured by Dow Chemical Company), 1.0 part of potassium persulfate, and 0.5 part of sodium thiosulfate are added to the core dispersion (15). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (15) over 11 hours at an addition rate of 0.62 mL/min and the resultant is further stirred for 5 hours.

The obtained content is cooled, and then washed with ion exchange water and dried, thereby obtaining toner particles (15) in which the styrene polymer is generated on surfaces of the cores. The volume average particle size of the toner particles (15) is 5.8 μm.

Preparation of Toner (15)

A toner (15) is obtained in the same manner as in the preparation of the toner (1), except that the toner particles (15) are used in place of the toner particles (1).

Preparation of Developer (15)

A developer (15) is obtained in the same manner as in the preparation of the developer (1), except that the toner (15) is used in place of the toner (1).

### Example 16

### Preparation of Toner Particles (16)

A core dispersion (16) is obtained in the same manner as in the preparation of the core dispersion (1) of Example 1, except that 153.5 parts of the binder resin dispersion (A1) is changed to 153.5 parts of the binder resin dispersion (A2), and 51.2 parts of the additional binder resin dispersion (A1) is changed to 51.2 parts of the binder resin dispersion (A2).

3.7 parts of a 20%-surfactant (Dowfax 2A1 manufactured by Dow Chemical Company), 1.0 part of potassium persulfate, and 0.5 part of sodium thiosulfate are added to the core dispersion (16). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (16) over 10 hours at an addition rate of 0.68 mL/min and the resultant is further stirred for 5 hours.

The obtained content is cooled, and then washed with ion exchange water and dried, thereby obtaining toner particles (16) in which the styrene polymer is generated on surfaces of the cores. The volume average particle size of the toner particles (16) is 6.0 μm.

Preparation of Toner (16)

A toner (16) is obtained in the same manner as in the preparation of the toner (1), except that the toner particles (16) are used in place of the toner particles (1).

Preparation of Developer (16)

A developer (16) is obtained in the same manner as in the preparation of the developer (1), except that the toner (16) is used in place of the toner (1).

### Example 17

### Preparation of Toner Particles (17)

A core dispersion (17) is obtained in the same manner as in the preparation of the core dispersion (1) of Example 1, except that 153.5 parts of the binder resin dispersion (A1) is changed to 153.5 parts of the binder resin dispersion (A3), and 51.2 parts of the additional binder resin dispersion (A1) is changed to 51.2 parts of the binder resin dispersion (A3).

3.7 parts of a 20%-surfactant (Dowfax 2A1 manufactured by Dow Chemical Company), 1.0 part of potassium persulfate, and 0.5 part of sodium thiosulfate are added to the core dispersion (17). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (17) over 10 hours at an addition rate of 0.68 mL/min and the resultant is further stirred for 5 hours.

The obtained content is cooled, and then washed with ion exchange water and dried, thereby obtaining toner particles (17) in which the styrene polymer is generated on surfaces of the cores. The volume average particle size of the toner particles (17) is 6.0 μm.

Preparation of Toner (17)

A toner (17) is obtained in the same manner as in the preparation of the toner (1), except that the toner particles (17) are used in place of the toner particles (1).

Preparation of Developer (17)

A developer (17) is obtained in the same manner as in the preparation of the developer (1), except that the toner (17) is used in place of the toner (1).

### Example 18

### Preparation of Toner Particles (18)

A core dispersion (18) is obtained in the same manner as in the preparation of the core dispersion (1) of Example 1, except that 153.5 parts of the binder resin dispersion (A1) is changed to 153.5 parts of the binder resin dispersion (A4), and 51.2 parts of the additional binder resin dispersion (A1) is changed to 51.2 parts of the binder resin dispersion (A4).

3.7 parts of a 20%-surfactant (Dowfax 2A1 manufactured by Dow Chemical Company), 1.0 part of potassium persulfate, and 0.5 part of sodium thiosulfate are added to the core dispersion (18). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (18) over 10 hours at an addition rate of 0.68 mL/min and the resultant is further stirred for 5 hours.

The obtained content is cooled, and then washed with ion exchange water and dried, thereby obtaining toner particles (18) in which the styrene polymer is generated on surfaces of the cores. The volume average particle size of the toner particles (18) is 6.0 μm.

Preparation of Toner (18)

A toner (18) is obtained in the same manner as in the preparation of the toner (1), except that the toner particles (18) are used in place of the toner particles (1).

Preparation of Developer (18)

A developer (18) is obtained in the same manner as in the preparation of the developer (1), except that the toner (18) is used in place of the toner (1).

### Example 19

### Preparation of Toner Particles (19)

A core dispersion (19) is obtained in the same manner as in the preparation of the core dispersion (1) of Example 1, except that 153.5 parts of the binder resin dispersion (A1) is changed to 153.5 parts of the binder resin dispersion (A5), and 51.2 parts of the additional binder resin dispersion (A1) is changed to 51.2 parts of the binder resin dispersion (A5).

3.7 parts of a 20%-surfactant (Dowfax 2A1 manufactured by Dow Chemical Company), 1.0 part of potassium persulfate, and 0.5 part of sodium thiosulfate are added to the core dispersion (19). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (19) over 10 hours at an addition rate of 0.68 mL/min and the resultant is further stirred for 5 hours.

The obtained content is cooled, and then washed with ion exchange water and dried, thereby obtaining toner particles (19) in which the styrene polymer is generated on surfaces of the cores. The volume average particle size of the toner particles (19) is 6.0 μm.

Preparation of Toner (19)

A toner (19) is obtained in the same manner as in the preparation of the toner (1), except that the toner particles (19) are used in place of the toner particles (1).

Preparation of Developer (19)

A developer (19) is obtained in the same manner as in the preparation of the developer (1), except that the toner (19) is used in place of the toner (1).

### Comparative Example 1

### Preparation of Toner Particles (C1)

The core dispersion (1) of Example 1 is prepared.

12.0 parts of a 20%-surfactant (Dowfax 2A1 manufactured by Dow Chemical Company), 1.0 part of potassium persulfate, and 0.5 part of sodium thiosulfate are added to the core dispersion (1). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (1) over 25 hours at an addition rate of 0.27 mL/min and the resultant is further stirred for 5 hours.

The obtained content is cooled, and then washed with ion exchange water and dried, thereby obtaining toner particles (C1) in which the styrene polymer is generated on surfaces of the cores. The volume average particle size of the toner particles (C1) is 5.6 μm.

Preparation of Toner (C1)

A toner (C1) is obtained in the same manner as in the preparation of the toner (1), except that the toner particles (C1) are used in place of the toner particles (1).

Preparation of Developer (C1)

A developer (C1) is obtained in the same manner as in the preparation of the developer (1), except that the toner (C1) is used in place of the toner (1).

### Comparative Example 2

### Preparation of Toner Particles (C2)

The core dispersion (1) of Example 1 is prepared. 4.0 parts of a 20%-surfactant (Dowfax 2A1 manufactured by Dow Chemical Company), 1.0 part of potassium persulfate, and 0.5 part of sodium thiosulfate are added to the core dispersion (1). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (1) over 4 hours at an addition rate of 1.7 mL/min and the resultant is further stirred for 5 hours.

The obtained content is cooled, and then washed with ion exchange water and dried, thereby obtaining toner particles (C2) in which the styrene polymer is generated on surfaces of the cores. The volume average particle size of the toner particles (C2) is 5.6 μm.

Preparation of Toner (C2)

A toner (C2) is obtained in the same manner as in the preparation of the toner (1), except that the toner particles (C2) are used in place of the toner particles (1).

Preparation of Developer (C2)

A developer (C2) is obtained in the same manner as in the preparation of the developer (1), except that the toner (C2) is used in place of the toner (1).

### Comparative Example 3

### Preparation of Toner Particles (C3)

Binder Resin Dispersion (B1): 157.3 parts

Binder Resin Dispersion (C1): 38.3 parts

Pigment Dispersion (1): 19.1 parts

Release Agent Dispersion (1): 28.2 parts

20%-Surfactant (Dowfax 2A1 manufactured by Dow Chemical Company): 7.0 parts

Ion Exchange Water: 1053.0 parts

The above materials are mixed in a round stainless-steel flask using a homogenizer (Ultra Turrax T50 manufactured by IKA-Werke Gmbh & Co. KG), and thus a dispersion is obtained. 42.1 parts of a 3%-aqueous aluminum sulfate solution is added to the dispersion and the content in the flask is stirred using a water bath with a stirring function. It is confirmed that the content in the flask is dispersed, and using a three-one motor (BLh300 manufactured by Shinto Scientific Co., Ltd.), the content is stirred at a stirring rotation rate of 150 rpm and then subjected to heating and stirring to 48.2° C. at a rate of temperature increase of 0.1° C./min. The obtained material is held for 240 minutes. Thereafter, 52.4 parts of the additional binder resin dispersion (B1) is added thereto and the resultant is stirred for 60 minutes. Next, 10.0 parts of a 10%-aqueous EDTA solution is added, and then the pH is adjusted to 8.5 with a 0.5 M-aqueous sodium hydroxide solution, thereby obtaining an aggregated particle dispersion.

Next, the temperature of the aggregated particle dispersion is increased to coalesce the aggregated particles over 6 hours at 80° C. The obtained material is cooled and then sufficiently washed with ion exchange water, thereby obtaining a core dispersion (C3) that is a dispersion of cores.

3.7 parts of a 20%-surfactant (Dowfax 2A1 manufactured by Dow Chemical Company), 1.0 part of potassium persulfate, and 0.5 part of sodium thiosulfate are added to the core dispersion (C3). While nitrogen substitution is carried out, these are subjected to heating and stirring to 38° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (C3) over 15 hours at an addition rate of 0.62 mL/min and the resultant is further stirred for 5 hours.

The obtained content is cooled, and then washed with ion exchange water and dried, thereby obtaining toner particles (C3) in which the styrene polymer is generated on surfaces of the cores. The volume average particle size of the toner particles (C3) is 5.9 μm.

Preparation of Toner (C3)

A toner (C3) is obtained in the same manner as in the preparation of the toner (1), except that the toner particles (C3) are used in place of the toner particles (1).

Preparation of Developer (C3)

A developer (C3) is obtained in the same manner as in the preparation of the developer (1), except that the toner (C3) is used in place of the toner (1).

### Comparative Example 4

### Preparation of Toner Particles (C4)

Binder Resin Dispersion (B2): 208.9 parts

Pigment Dispersion (1): 19.1 parts

Release Agent Dispersion (1): 28.2 parts

20%-Surfactant (Dowfax 2A1 manufactured by Dow Chemical Company): 7.0 parts

Ion Exchange Water: 1053.0 parts

The above materials are mixed in a round stainless-steel flask using a homogenizer (Ultra Turrax T50 manufactured by IKA-Werke Gmbh & Co. KG), and thus a dispersion is obtained. 42.1 parts of a 3%-aqueous aluminum sulfate solution is added to the dispersion and the content in the flask is stirred using a water bath with a stirring function. It is confirmed that the content in the flask is dispersed, and using a three-one motor (BLh300 manufactured by Shinto Scientific Co., Ltd.), the content is stirred at a stirring rotation rate of 150 rpm and then subjected to heating and stirring to 48.2° C. at a rate of temperature increase of 0.1° C./min. The obtained material is held for 240 minutes. Thereafter, 69.6 parts of the additional binder resin dispersion (B2) is added thereto and the resultant is stirred for 60 minutes. Next, 10.0 parts of a 10%-aqueous EDTA solution is added, and then the pH is adjusted to 8.5 with a 0.5 M-aqueous sodium hydroxide solution, thereby obtaining an aggregated particle dispersion.

Next, the temperature of the aggregated particle dispersion is increased to coalesce the aggregated particles over 6 hours at 80° C. The obtained material is cooled and then sufficiently washed with ion exchange water, thereby obtaining a core dispersion (C4) that is a dispersion of cores.

3.7 parts of a 20%-surfactant (Dowfax 2A1 manufactured by Dow Chemical Company), 1.0 part of potassium persulfate, and 0.5 part of sodium thiosulfate are added to the core dispersion (C4). While nitrogen substitution is carried out, these are subjected to heating and stirring to 40° C. at a rate of temperature increase of 0.1° C./min, and stirred for 120 minutes.

Separately, 2.0 parts of a 20%-surfactant (Dowfax 2A1 manufactured by Dow Chemical Company), 7.0 parts of styrene, and 400 parts of ion exchange water are mixed to prepare a styrene dispersion in which the styrene is dispersed in the form of micelles, and the styrene dispersion is added to the core dispersion (C4) over 10 hours at an addition rate of 0.68 mL/min and the resultant is further stirred for 5 hours.

The obtained content is cooled, and then washed with ion exchange water and dried, thereby obtaining toner particles (C4) in which the styrene polymer is generated on surfaces of the cores. The volume average particle size of the toner particles (C4) is 5.7 μm.

Preparation of Toner (C4)

A toner (C4) is obtained in the same manner as in the preparation of the toner (1), except that the toner particles (C4) are used in place of the toner particles (1).

Preparation of Developer (C4)

A developer (C4) is obtained in the same manner as in the preparation of the developer (1), except that the toner (C4) is used in place of the toner (1).

Toner Analysis by XPS

A surfactant (Contaminon manufactured by Wako Pure Chemical Industries, Ltd.) is added to ion exchange water, and a toner is added thereto and mixed and dispersed. Ultrasonic waves are applied to the dispersion to remove an external additive (silica) from the toner. Thereafter, the dispersion is allowed to pass through filter paper and a residual material on the filter paper is washed with ion exchange water and dried, thereby obtaining toner particles.

From peak intensities of the elements of the above-described toner particles, measured by a photoelectron spectrometer, a peak component derived from the polyester and a peak component derived from the vinyl polymer are extracted using a relative sensitivity factor provided by Physical Electronics Industries, Inc. (PHI) to calculate a proportion A (atomic concentration (atom %)) of the atoms constituting the polyester in the entire atoms and a proportion B (atomic concentration (atom %)) of the atoms constituting the vinyl polymer in the entire atoms. Then, B/(A+B) is calculated.

The photoelectron spectrometer and the measurement conditions are as follows.

Device: X-ray Photoelectron Spectrometer 1600S manufactured by PHI

X-ray Source: MgKα (400 W)

Spectral Region Diameter 800 μm

Evaluation

ApeosPort IV C3370 manufactured by Fuji Xerox Co., Ltd. is provided as an image forming apparatus for evaluation, and a toner developing machine is filled with the developers of the examples and the comparative examples. The nip width of a fixing device is 6 mm, the nip pressure is 1.6 kgf/cm², the Dwell time is 34.7 ms, and the paper transport velocity of the fixing device is 175 mm/sec.

First, a high-density image (image density: 100%) is continuously output on 100 pieces of Miller Coat Platinum Paper having a A4 size (basis weight: 256 g/m²) manufactured by Oji Paper Co., Ltd., under conditions that a set temperature of a heating belt is 110° C. and a measurement temperature of a pressing roll is 60° C.

Simultaneously after the above-described output, a half-tone image (image density: 5%) is output on a sheet of SP paper having a A4 size (basis weight: 60 g/m²) manufactured by Fuji Xerox InterField Co., Ltd., under conditions that a set temperature of the heating belt is 110° C. and a measurement temperature of the pressing roll is 60° C.

Image deletion of the output half-tone image is observed with the naked eye to perform the evaluation based on the following standards. The results thereof are shown in Table 3.

G1: No image deletion occurs.

G2: It is difficult to recognize image deletion.

G3: Image deletion slightly occurs.

G4: Image deletion is more deteriorated as compared with G3, but there are no problems in practical use. Acceptable level.

G5: Image deletion is clearly recognized. Not acceptable level in practical use.

TABLE 3

| | | | | Number of | | | | | | |
|---|---|---|---|---|---|---|---|---|---|---|
| | | | | Carbon | | | | | | |
| | | | | Atoms | | | | | | |
| | | | | of Side | | | | | | |
| | | | | Chain of | Presence of | | Polymerization | | | |
| | | Toner/ | Amorphous | Long-Chain | Crystalline | Core Manufacturing | Condition of | | | Evalua- |
| | | Developer | Resin | Alkyl | Resin | Method | Shell | \|Tc − Tw\| | B/(A + B) | tion |
| Examples | 1 | (1) | Amorphous | 12 | Presence | Aggregation Coalescence | Aqueous | 4 | 0.45 | G1 |
| | | | Saturated | | | | | | | |
| | | | Polyester | | | | | | | |
| | | | Resin (A1) | | | | | | | |
| | 2 | (2) | Amorphous | 12 | Presence | Aggregation Coalescence | Aqueous | 4 | 0.32 | G2 |
| | | | Saturated | | | | | | | |
| | | | Polyester | | | | | | | |
| | | | Resin (A1) | | | | | | | |
| | 3 | (3) | Amorphous | 12 | Presence | Aggregation Coalescence | Aqueous | 4 | 0.53 | G2 |
| | | | Saturated | | | | | | | |
| | | | Polyester | | | | | | | |
| | | | Resin (A1) | | | | | | | |
| | 4 | (4) | Amorphous | 12 | Presence | Aggregation Coalescence | Aqueous | 4 | 0.12 | G3 |
| | | | Saturated | | | | | | | |
| | | | Polyester | | | | | | | |
| | | | Resin (A1) | | | | | | | |
| | 5 | (5) | Amorphous | 12 | Presence | Aggregation Coalescence | Aqueous | 4 | 0.69 | G3 |
| | | | Saturated | | | | | | | |
| | | | Polyester | | | | | | | |
| | | | Resin (A1) | | | | | | | |
| | 6 | (6) | Amorphous | 12 | Presence | Aggregation Coalescence | Aqueous | 4 | 0.12 | G3 |
| | | | Saturated | | | | | | | |
| | | | Polyester | | | | | | | |
| | | | Resin (A1) | | | | | | | |
| | 7 | (7) | Amorphous | 12 | Presence | Kneading Pulverization | Aqueous | 4 | 0.44 | G3 |
| | | | Saturated | | | | | | | |
| | | | Polyester | | | | | | | |
| | | | Resin (A1) | | | | | | | |
| | 8 | (8) | Amorphous | 12 | None | Aggregation Coalescence | Aqueous | — | 0.45 | G3 |
| | | | Saturated | | | | | | | |
| | | | Polyester | | | | | | | |
| | | | Resin (A1) | | | | | | | |
| | 9 | (9) | Amorphous | 12 | Presence | Aggregation Coalescence | Aqueous | 2 | 0.45 | G1 |
| | | | Saturated | | | | | | | |
| | | | Polyester | | | | | | | |
| | | | Resin (A1) | | | | | | | |
| | 10 | (10) | Amorphous | 12 | Presence | Aggregation Coalescence | Aqueous | 8 | 0.43 | G1 |
| | | | Saturated | | | | | | | |
| | | | Polyester | | | | | | | |
| | | | Resin (A1) | | | | | | | |
| | 11 | (11) | Amorphous | 12 | Presence | Aggregation Coalescence | Aqueous | 12 | 0.45 | G2 |
| | | | Saturated | | | | | | | |
| | | | Polyester | | | | | | | |
| | | | Resin (A1) | | | | | | | |
| | 12 | (12) | Amorphous | 12 | Presence | Aggregation Coalescence | Aqueous | 18 | 0.45 | G2 |
| | | | Saturated | | | | | | | |
| | | | Polyester | | | | | | | |
| | | | Resin (A1) | | | | | | | |
| | 13 | (13) | Amorphous | 12 | Presence | Aggregation Coalescence | Aqueous | 22 | 0.42 | G3 |
| | | | Saturated | | | | | | | |
| | | | Polyester | | | | | | | |
| | | | Resin (A1) | | | | | | | |
| | 14 | (14) | Amorphous | 12 | Presence | Aggregation Coalescence | Aqueous | 28 | 0.46 | G3 |
| | | | Saturated | | | | | | | |
| | | | Polyester | | | | | | | |
| | | | Resin (A1) | | | | | | | |
| | 15 | (15) | Amorphous | 12 | Presence | Aggregation Coalescence | Aqueous | 31 | 0.45 | G4 |
| | | | Saturated | | | | | | | |
| | | | Polyester | | | | | | | |
| | | | Resin (A1) | | | | | | | |
| | 16 | (16) | Amorphous | 7 | Presence | Aggregation Coalescence | Aqueous | 4 | 0.46 | G3 |
| | | | Saturated | | | | | | | |
| | | | Polyester | | | | | | | |
| | | | Resin (A2) | | | | | | | |
| | 17 | (17) | Amorphous | 8 | Presence | Aggregation Coalescence | Aqueous | 4 | 0.47 | G2 |
| | | | Saturated | | | | | | | |
| | | | Polyester | | | | | | | |
| | | | Resin (A3) | | | | | | | |
| | 18 | (18) | Amorphous | 18 | Presence | Aggregation Coalescence | Aqueous | 4 | 0.47 | G2 |
| | | | Saturated | | | | | | | |
| | | | Polyester | | | | | | | |
| | | | Resin (A4) | | | | | | | |
| | 19 | (19) | Amorphous | 19 | Presence | Aggregation Coalescence | Aqueous | 4 | 0.44 | G3 |
| | | | Saturated | | | | | | | |
| | | | Polyester | | | | | | | |
| | | | Resin (A5) | | | | | | | |
| Comparative | 1 | (C1) | Amorphous | 12 | Presence | Aggregation Coalescence | Aqueous | 4 | 0.09 | G5 |
| Examples | | | Saturated | | | | | | | |
| | | | Polyester | | | | | | | |
| | | | Resin (A1) | | | | | | | |
| | 2 | (C2) | Amorphous | 12 | Presence | Aggregation Coalescence | Aqueous | 4 | 0.72 | G5 |
| | | | Saturated | | | | | | | |
| | | | Polyester | | | | | | | |
| | | | Resin (A1) | | | | | | | |
| | 3 | (C3) | Amorphous | 12 | Presence | Aggregation Coalescence | Aqueous | 4 | 0.43 | G5 |
| | | | Unsaturated | | | | | | | |
| | | | Polyester | | | | | | | |
| | | | Resin (B1) | | | | | | | |
| | 4 | (C4) | Amorphous | 4 | None | Aggregation Coalescence | Aqueous | — | 0.43 | G5 |
| | | | Polystyrene- | | | | | | | |
| | | | Acrylic | | | | | | | |
| | | | Resin (B2) | | | | | | | |

As will be noted from Table 3, image deletion is difficult to occur with the toners of the examples, as compared with the toners of the comparative examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles that have a core containing polyester, a release agent, and a colorant in which the polyester does not have an ethylenically unsaturated bond, and a shell coating the core and containing a polymer of vinyl monomers,
wherein the toner particles satisfy the following Expression (1):
0.1≦B/(A+B)≦0.7 Expression (1):
wherein in Expression (1), A represents a proportion (atom %) of atoms constituting the polyester in the entire atoms, that is obtained by analyzing surfaces of the toner particles by X-ray photoelectron spectroscopy; and B represents a proportion (atom %) of atoms constituting the polymer of vinyl monomers in the entire atoms, that is obtained by analyzing the surfaces of the toner particles by X-ray photoelectron spectroscopy.

2. The electrostatic charge image developing toner according to claim 1,
wherein the core contains crystalline polyester.

3. The electrostatic charge image developing toner according to claim 1,
wherein the polyester is obtained using a dicarboxylic acid having an alkyl group with from 8 to 20 carbon atoms as a polymerization component.

4. The electrostatic charge image developing toner according to claim 2,
wherein a melting temperature Tc of the crystalline polyester and a melting temperature Tw of the release agent satisfy the following expression:

|Tc−Tw|≦30.

5. The electrostatic charge image developing toner according to claim 3,
wherein a proportion of the dicarboxylic acid having an alkyl group with from 8 to 20 carbon atoms in a polyvalent carboxylic acid that is a polymerization component is from 2 mol % to 10 mol %.

6. The electrostatic charge image developing toner according to claim 1,
wherein the value of B/(A+B) is from 0.2 to 0.6.

7. The electrostatic charge image developing toner according to claim 1,
wherein a proportion of amorphous saturated polyester is from 40% by weight to 95% by weight.

8. The electrostatic charge image developing toner according to claim 2,
wherein the crystalline polyester is obtained using, as a monomer, a straight chain aliphatic diol with from 7 to 20 carbon atoms in a main chain part.

9. The electrostatic charge image developing toner according to claim 1,
wherein the toner particles are toner particles in which a shell is formed on a surface of the core by polymerizing vinyl monomers in a solvent.

10. The electrostatic charge image developing toner according to claim 1,
wherein the core is formed by coalescing aggregated particles by heating, in a dispersion in which polyester that does not have an ethylenically unsaturated bond, a release agent, and a colorant are dispersed, the aggregated particles containing the polyester, the release agent, and the colorant.

11. An electrostatic charge image developer comprising:
the electrostatic charge image developing toner according to claim 1.

12. A toner cartridge that has a toner accommodating chamber,
wherein the toner accommodating chamber contains the electrostatic charge image developing toner according to claim 1.

13. A process cartridge that has an accommodating chamber for the electrostatic charge image developer according to claim 11 and has a developing unit that develops an electrostatic charge image with the electrostatic charge image developer.

14. An image forming apparatus comprising:
an image holding member;
a charging unit that charges a surface of the image holding member;
an electrostatic charge image forming unit that forms an electrostatic charge image on the surface of the image holding member;
a developing unit that develops the electrostatic charge image formed on the surface of the image holding member with a developer including a toner to form a toner image;
a transfer unit that transfers the toner image onto a surface of a transfer member from the image holding member; and
a fixing unit that fixes the toner image transferred onto the surface of the transfer member,
wherein the toner is the electrostatic charge image developing toner according to claim 1.

15. An image forming method comprising:
charging a surface of an image holding member;
forming an electrostatic charge image on the surface of the image holding member;
developing the electrostatic charge image formed on the surface of the image holding member with a developer including a toner to form a toner image;
transferring the toner image onto a surface of a transfer member; and
fixing the toner image transferred onto the surface of the transfer member,
wherein the toner is the electrostatic charge image developing toner according to claim 1.
